(19) United States
(12) Patent Application Publication
(10) Pub. No.: US 2025/0233741 A1
(43) Pub. Date: Jul. 17, 2025

(54) UE DISCOVERY MESSAGE PROTECTION METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/833,752

(22) PCT Filed: Jan. 29, 2022
(86) PCT No.: PCT/CN2022/075127

§ 371 Date: Mar. 24, 2025

(51) Int. Cl. H04L 9/08; H04L 9/32; H04W 12/037; H04W 48/16

(52) U.S. Cl. CPC H04L 9/088; H04L 9/32; H04W 12/037; H04W 48/16

(57) ABSTRACT

A method, communication device, and a storage medium for protecting user equipment (UE) discovery messages. The UE discovery messages are protected by sending a first announcement message in response to determining that the first UE is located outside a network coverage range, where the first announcement message includes: a discovery message encrypted based on a discovery key, and LTK identifier information (ID) indicating an LTK, where the discovery key is determined based on the LTK received in response to determining that the first UE is located within the network coverage range, and the LTK ID is used for allowing a second UE to determine a key request to request the discovery key or request to generate an intermediate key of the discovery key.

### CROSS REFERENCE TO RELATED APPLICATION

The present application is a U.S. National Stage of International Application No. PCT/CN2022/075127, filed on Jan. 29, 2022, the contents of all of which are incorporated herein by reference in their entireties for all purposes.

### BACKGROUND OF THE INVENTION

In a wireless communication system, for example, in a 5th generation mobile communication (5G) system, some user equipment (UE) is within a 5G network coverage range, and some UE is outside the 5G network coverage range. A ranging service may be supported regardless of whether the UE is within the 5G coverage range or not.

Before ranging on target UE, observer UE needs to detect and identify the nearby target UE by utilizing a discovery message of ranging. For a Type B constrained ranging discovery process, discoverer UE announces a discovery message on a proximity communication (PC5) interface, and this discovery message may contain a content about a discovery of interest. The discoverer UE receiving the message may respond with some information related to the discovery message sent by the discoverer UE. In the Type B constrained ranging discovery process without a privacy protection mechanism, the discovery message contains the privacy of the UE involved in the ranging process. In 5G network communications, a discovery key with a validity duration may be provided for ranging-enabled UE to help protect discovery messages when all ranging-enabled UE is covered by 5G.

### SUMMARY OF THE INVENTION

The disclosure relates to, but is not limited to, the technical field of communications, in particular to a UE discovery message protection method and apparatus, a communication device, and a storage medium.

Examples of the disclosure publicly provide a UE discovery message protection method and apparatus, a communication device, and a storage medium.

According to a first aspect of the disclosure, a UE discovery message protection method is provided and executed by first UE, and includes:
sending a first announcement message in response to determining that the first UE is located outside a network coverage range, where the first announcement message includes: a discovery message encrypted based on a discovery key, and long-term key (LTK) identifier information (ID) indicating an LTK;
where the discovery key is determined based on the LTK received in response to determining that the first UE is located within the network coverage range, and the LTK ID is used for allowing second UE to determine a key request to request the discovery key or request to generate an intermediate key (KD) of the discovery key.

According to a second aspect of the disclosure, a UE discovery message protection method is provided and executed by second UE, and includes:
sending a key request to a ranging key management function (RKMF) based on monitoring a first announcement message; where the first announcement message is sent in response to determining that first UE is located outside a network coverage range and includes: a discovery message encrypted based on a discovery key, and LTK ID indicating an LTK;
where the discovery key is determined by the first UE based on the LTK received in response to determining being within the network coverage range;
where the key request includes: the LTK ID; and the key request is used for requesting the discovery key or requesting to generate a KD of the discovery key.

According to a third aspect of the disclosure, a UE discovery message protection method is provided and executed by an RKMF, and includes:
receiving a key request sent by second UE, where the key request is sent after the second UE monitors a first announcement message; where the first announcement message is sent in response to determining that first UE is located outside a network coverage range and includes: a discovery message encrypted based on a discovery key, and LTK ID indicating an LTK; where the discovery key is determined by the first UE based on the LTK received in response to determining being within the network coverage range; and the key request includes: the LTK ID; and
determining the discovery key corresponding to the LTK ID or generating a KD of the discovery key based on the key request.

According to a fourth aspect of the disclosure, a communication device is provided, including:
a processor; and
a memory configured to store executable instructions for the processor;
where the processor is configured to: implement the UE discovery message protection method of any example of the disclosure when running the executable instructions.

According to a fifth aspect of the disclosure, a computer storage medium is provided and stores a computer executable program, and the executable program implements the UE discovery message protection method of any example of the disclosure in response to determining being executed by a processor.

It is to be understood that the above general descriptions and later detailed descriptions are merely examples and illustrative, and cannot limit the examples of the disclosure.

### BRIEF DESCRIPTION OF DRAWINGS

FIG. 1 is a schematic structural diagram of a wireless communication system.

FIG. 2 is a schematic diagram of position determination illustrated according to an example.

FIG. 3 is a schematic diagram of network coverage illustrated according to an example.

FIG. 4 is a schematic diagram of network coverage illustrated according to an example.

FIG. 5 is a schematic diagram of network coverage illustrated according to an example.

FIG. 6 is a flow diagram of a UE discovery message protection method illustrated according to an example.

FIG. 7 is a flow diagram of a UE discovery message protection method illustrated according to an example.

FIG. 8 is a flow diagram of a UE discovery message protection method illustrated according to an example.

FIG. 9 is a flow diagram of a UE discovery message protection method illustrated according to an example.

FIG. 10 is a flow diagram of a UE discovery message protection method illustrated according to an example.

FIG. 11 is a flow diagram of a UE discovery message protection method illustrated according to an example.

FIG. 12 is a flow diagram of a UE discovery message protection method illustrated according to an example.

FIG. 13 is a flow diagram of a UE discovery message protection method illustrated according to an example.

FIG. 14 is a block diagram of a UE discovery message protection apparatus illustrated according to an example.

FIG. 15 is a block diagram of a UE discovery message protection apparatus illustrated according to an example.

FIG. 16 is a block diagram of a UE discovery message protection apparatus illustrated according to an example.

FIG. 17 is a block diagram of UE illustrated according to an example.

FIG. 18 is a block diagram of a base station illustrated according to an example.

### DETAILED DESCRIPTION OF THE INVENTION

Examples will be illustrated in detail here, and their instances are shown in accompanying drawings. When the following description refers to the accompanying drawings, unless otherwise indicated, the same numbers in different accompanying drawings indicate the same or similar elements. Embodiments described in the following examples do not represent all embodiments consistent with the examples of the disclosure. Rather, they are merely instances of apparatuses and methods consistent with some aspects of the examples of the disclosure as detailed in the appended claims.

Terms used in the examples of the disclosure are merely for the purpose of describing specific embodiments, and are not intended to limit the examples of the disclosure. Singular forms “one” and “the” used in the examples of the disclosure and the appended claims are also intended to include plural forms unless the context clearly indicates other meanings. It is also to be understood that a term “and/or” as used here refers to and contains any or all possible combinations of one or more associated listed items.

It is to be understood that although terms first, second, third, etc. may be used to describe various information in the examples of disclosure, such information is not to be limited to these terms. These terms are merely used to distinguish the same type of information from each other. For example, without departing from the scope of the examples of the disclosure, first information may also be referred to as second information, and similarly, the second information may also be referred to as the first information. Depending on the context, for example, a word “if” as used here may be interpreted as “at the time” or “when” or “in response to determining”.

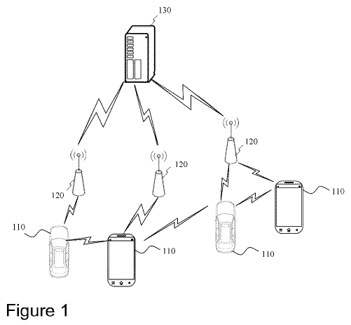

Referring to FIG. 1, it shows a schematic structural diagram of a wireless communication system provided by an example of the disclosure. As shown in FIG. 1, the wireless communication system is a communication system based on a cellular mobile communication technology. The wireless communication system may include: a plurality of pieces of user equipment 110 and a plurality of base stations 120.

The user equipment 110 may refer to devices that provide a user with speech and/or data connectivity. The user equipment 110 may communicate with one or more core networks via a radio access network (RAN), and the user equipment 110 may be Internet of Things user equipment, such as a sensor device, a mobile phone (or “cellular” phone), and a computer with the Internet of Things user equipment, which may be, for example, fixed, portable, pocket-sized, handheld, computer-built, or vehicle-mounted apparatuses, for example, a station (STA), a subscriber unit, a subscriber station, a mobile station, a mobile, a remote station, an access point, a remote terminal, an access terminal, a user terminal, a user agent, a user device, or user equipment. Or, the user equipment 110 may also be unmanned aircraft devices. Or, the user equipment 110 may also be vehicle-mounted devices, such as a trip computer with a wireless communication function, or wireless communication equipment connected with an external trip computer. Or, the user equipment 110 may also be roadside devices, such as a street lamp, a signal light or other roadside devices with wireless communication functions.

The base stations 120 may be network side devices in the wireless communication system. The wireless communication system may be the 4th generation mobile communication (4G) system, also known as a long term evolution (LTE) system; or, the wireless communication system may be a 5G system, also known as a new radio system or 5G NR system. Or, the wireless communication system may also be a next-generation system of the 5G system. An access network in the 5G system may be called a new generation-radio access network (NG-RAN).

The base stations 120 may be evolved base stations (eNB) adopted in the 4G system. Or, the base stations 120 may also be base stations (gNB) adopting centralized and distributed architectures in the 5G system. When the base stations 120 adopt the centralized and distributed architectures, they typically each include a central unit (CU) and at least two distributed units (DUs). Protocol stacks of a packet data convergence protocol (PDCP) layer, a radio link control (RLC) layer, and a media access control (MAC) layer are arranged in the central unit. A physical (PHY) layer protocol stack is arranged in the distributed unit. The examples of the disclosure do not limit specific embodiment of the base stations 120.

Wireless connections may be established between the base stations 120 and the user equipment 110 through wireless radio. In different embodiments, the wireless radio is wireless radio based on the 4th generation mobile communication (4G) standard; or, the wireless radio is wireless radio based on the 5th generation mobile communication (5G) standard, such as new radio; or, the wireless radio may also be wireless radio based on the next-generation mobile communication standard of 5G.

In some examples, end to end (E2E) connections may also be established between the user equipment 110, for example, a vehicle to vehicle (V2V) communication, a vehicle to infrastructure (V2I) communication, a vehicle to pedestrian (V2P) communication and other scenarios in vehicle to everything (V2X) communications.

Here, the above user equipment may be considered to be a terminal device of the following example.

In some examples, the wireless communication system above may further include a network management device 130.

The plurality of base stations 120 are connected with the network management device 130. The network management device 130 may be a core network device in the wireless communication system, for example, the network management device 130 may be a mobility management entity (MME) in an evolved packet core (EPC). Or, the network management device may also be other core network devices, such as a serving gateway (SGW), a public data network gateway (PGW), a policy and charging rules function (PCRF) or a home subscriber server (HSS). An embodiment form of the network management device 130 is not limited in the examples of the disclosure.

In a wireless communication system, for example, in a 5th generation mobile communication (5G) system, some user equipment (UE) is within a 5G network coverage range, and some UE is outside the 5G network coverage range. A ranging service may be supported regardless of whether the UE is within the 5G coverage range or not.

Before ranging on target UE, observer UE needs to detect and identify the nearby target UE by utilizing a discovery message of ranging. For a Type B constrained ranging discovery process, discoverer UE announces a discovery message on a proximity communication (PC5) interface, and this discovery message may contain a content about a discovery of interest. The discoverer UE receiving the message may respond with some information related to the discovery message sent by the discoverer UE. In the Type B constrained ranging discovery process without a privacy protection mechanism, the discovery message contains the privacy of the UE involved in the ranging process. In 5G network communications, a discovery key with a validity duration may be provided for ranging-enabled UE to help protect discovery messages when all ranging-enabled UE is covered by 5G.

However, in some 5G coverage scenarios, when the ranging-enabled UE has an expired discovery key and it is not covered by the 5G network, the discovery message cannot be protected, which will put the discovery key at risk of being leaked as well as degrade user experience.

In order to facilitate understanding by those skilled in the art, the examples of the disclosure set forth a plurality of embodiments to clearly illustrate the technical solutions of the examples of the disclosure. Certainly, it may be understood by those skilled in the art that the plurality of examples provided in the examples of the disclosure may be executed individually, or together with methods of other examples in the examples of the disclosure when combined, or together with some methods in other related arts after being executed individually or in combination, which is not limited by the examples of the disclosure.

In order to better understand the technical solution described in any one of the examples of the disclosure, first, positioning in the related art is described.

In one example, a ranging service means determining, via a proximity communication connection, at least one piece of the following information: a distance between two pieces of UE, or a direction from one piece of UE to the other piece of UE.

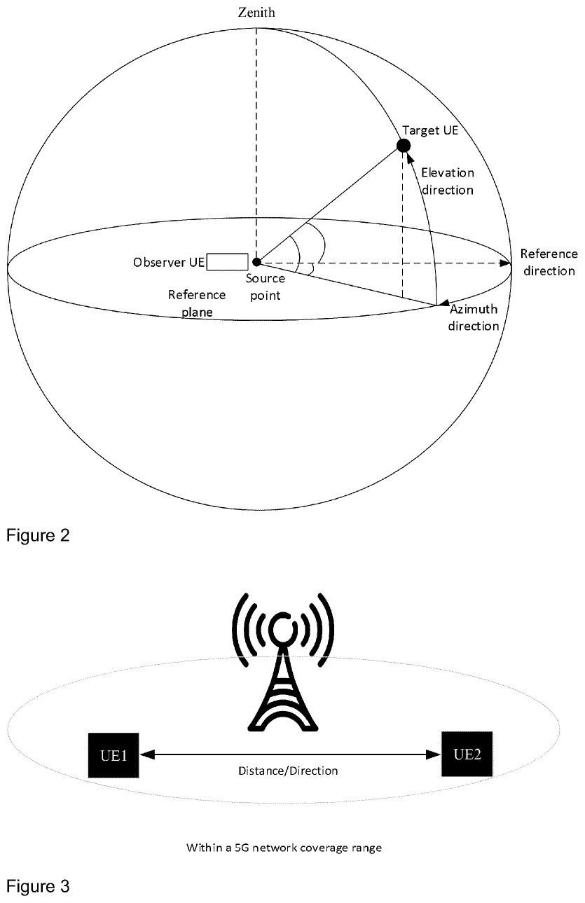

In one example, as shown in FIG. 2, observer UE has a reference plane and a reference direction. A direction from target UE to the observer UE is: an included angle between a connection line of the observer UE and the target UE and the reference direction. This included angle is represented by an azimuth direction and/or an elevation direction. The azimuth direction of the target UE is an angular direction formed by the reference direction and a projection of a straight line from the observer UE to the target UE on the same plane as the reference direction perpendicular to a zenith. The elevation direction of the target UE is an angular direction of the two in a vertical direction (above a horizontal plane).

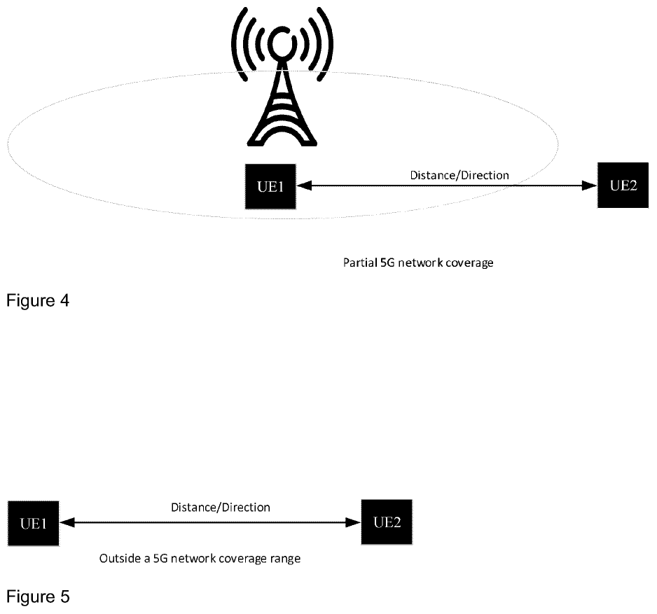

In one example, the ranging service may be supported whether or not it is within a 5G network coverage range. As shown in FIG. 3, an illustration of 5G network coverage is provided; and both UE1 and UE2 are within the 5G network coverage range. FIG. 4 provides an illustration of partial 5G network coverage; and UE1 is within the 5G network coverage range and UE2 is outside the 5G network coverage range. FIG. 5 provides an illustration without 5G network coverage; and both UE1 and UE2 are not within the 5G network coverage range. In one example, if a licensed band is used for ranging, it may be completely controlled by an operator.

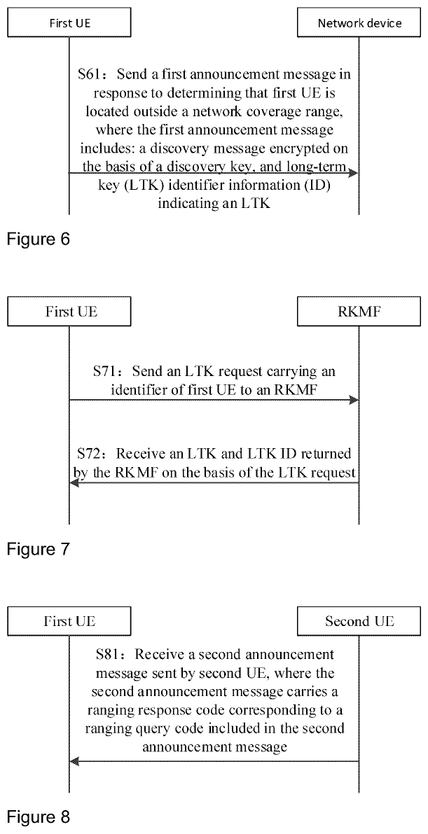

As shown in FIG. 6, an example of the disclosure publicly provides a UE discovery message protection method, executed by first UE, and including:
step S61: a first announcement message is sent in response to determining that the first UE is located outside a network coverage range, where the first announcement message includes: a discovery message encrypted on the basis of a discovery key, and long-term key (LTK) identifier information (ID) indicating an LTK;
where the discovery key is determined on the basis of the LTK received in response to determining that the first UE is located within the network coverage range, and the LTK ID is used for allowing second UE to determine a key request to request the discovery key or request to generate an intermediate key (KD) of the discovery key.

In one example, both the first UE and the second UE may be, but are not limited to, various mobile terminals or fixed terminals; for example, both the first UE and the second UE may be, but are not limited to, a cellphone, a computer, a server, a wearable device, a game control platform or a multimedia device, and the like. In all examples of the disclosure, the first UE may be announcing UE, which may be observer UE or discoverer UE, and the second UE may be monitoring UE, which may be observer UE or discoverer UE. Or, the first UE may be monitoring UE, which may be observer UE or discoverer UE, and the second UE may be announcing UE, which may be observer UE or discoverer UE. In all examples of the disclosure, the second UE monitors a first announcement message when the first UE sends the first announcement message, and the first UE monitors a second announcement message when the second UE sends the second announcement message. The first UE and the second UE may be monitoring UE or sending UE for each other, and the first UE and the second UE may also both be discoverer UE or observer UE.

In one example, the first UE is located outside the network coverage range and the second UE is located within the network coverage range. In another example, the first UE is located outside the network coverage range, the second UE is located within the network coverage range, and the second UE is located near the first UE.

In one example, network coverage may refer to coverage of various networks, for example, the network coverage may be, but is not limited to, 4G network coverage, 5G network coverage, or other evolved network coverage, and the like. For example, the first announcement message is sent when the first UE is located outside the 5G network coverage range.

Sending the first announcement message in step S61 includes: sending the first announcement message on the basis of a proximity communication (PC5) interface.

An example of the disclosure provides a UE discovery message protection method, executed by first UE, and including: a first announcement message is sent at a PC5 interface when the first UE is located outside a network coverage range.

Here, the first UE and second UE may communicate with each other by adopting the PC5 interface whether or not they are within the network coverage range. For example, the first UE is located outside the network coverage range, the second UE is located within the network coverage range, and the PC5 interface may be adopted for a communication.

The first announcement message includes, but is not limited to, at least one of the following:
a discovery message encrypted on the basis of a discovery key;
LTK ID indicating an LTK;
a security algorithm identity, used for identifying a security algorithm used by the first announcement message;
a ranging query code used for identifying the first announcement message;
a nonce, used for determining the discovery key together with the LTK; or
a time stamp, used for indicating a validity duration of the discovery key.

Here, the nonce may also be used for decrypting the discovery message together with the discovery key.

In one example, the security algorithm may be any one encryption algorithm, which is not limited here.

In one example, the ranging query code may be used for identifying target UE indicated in the first announcement message. For example, different first announcement messages correspond to different ranging query codes, and target ranging layer ID may be the same or different in the different first announcement messages.

In one example, if the ranging query code is located in the encrypted discovery message, the ranging query code may be used for indicating the target UE that needs ranging; or, if the ranging query code is included in the first announcement message but is not included in the encrypted discovery message, the ranging query code may be used for indicating the first announcement message.

The discovery message includes, but is not limited to, at least one of the following:
a time stamp, used for indicating a validity duration of the discovery key;
target ranging layer identification information (ID), used for indicating the target UE that needs ranging; or
ranging requirement information, used for indicating ranging requirements for ranging.

In one example, the time stamp may be included in the discovery message of the first announcement message. In this way, the discovery message needs to be decrypted to obtain the time stamp.

In another example, the time stamp is included in the first announcement message but not included in the discovery message. In this way, the time stamp may be obtained merely after an integrity verification of the first announcement message, which facilitates the judgment of a replay attack on the first announcement message without decrypting the discovery message.

Here, the first UE may determine the target UE that needs ranging before moving out of the network coverage range.

The discovery key includes at least one of the following:
a ranging encryption key (REK), used for encrypting the discovery message; or
a ranging integrity key (RIK), used for protecting integrity of the first announcement message.

Here, the discovery message includes sensitive information. The sensitive information is at least a part of the discovery message. For example, the discovery message includes the target ranging layer ID and the ranging requirement information, and the sensitive information may be a ranging time in the ranging requirement information.

In one example, the REK may be used for encrypting the sensitive information in the discovery message.

For example, if the sensitive information is a part of the discovery message, e.g., the discovery message includes the target ranging layer ID and the ranging requirement information, the sensitive information may be the ranging time in the ranging requirement information, the REK may be used for encrypting the ranging time and not encrypting information other than the ranging time in the ranging requirement information and the target ranging layer ID.

For another example, if the sensitive information is the entire message in the discovery message, the PEK may be used for encrypting the entire discovery message.

In one example, the discovery message encrypted on the basis of the discovery key in step S61 may be: a discovery message encrypted on the basis of the REK in the discovery key.

In one example, the discovery message is encrypted on the basis of the REK, and the integrity of the first announcement message is protected on the basis of the RIK, i.e., the discovery key protects the first announcement message. For example, the first UE utilizes the REK to encrypt the discovery message in the first announcement message, such as encrypting at least one of the ranging requirement information, the target ranging layer ID, the time stamp, or the ranging query code. The first UE utilizes the RIK to protect the integrity of at least one of the security algorithm identity, the encrypted discovery message, or the nonce to form the first announcement message. The first UE announces the first announcement message at the PC5 interface.

In the example of the disclosure, the first announcement message may be sent by the first UE when the first UE is located outside the network coverage range. The first announcement message includes: the discovery message encrypted on the basis of the discovery key, and the LTK ID indicating the LTK. This may enable the first UE to still be able to announce the first announcement message when the first UE is located outside the network coverage range. The discovery key is determined on the basis of the LTK received when the first UE is located within the network coverage range, and the LTK ID is used for allowing the second UE to determine the key request to request the discovery key or request to generate the KD of the discovery key. This enables the second UE to obtain the discovery key or generate the KD of the discovery key, i.e., the UE within the network coverage range can decrypt the discovery message merely on the basis of the discovery key or generating the KD of the discovery key. In this way, the examples of the disclosure may enable the second UE within the network coverage range to obtain the encrypted discovery message of the first UE outside the network coverage range, which can realize the protection of the discovery message, i.e., it can provide the protection of the discovery message in part of network coverage scenarios (e.g., in part of 5G network coverage scenarios), and thus user experience may be improved as well.

An example of the disclosure provides a UE discovery message protection method, executed by first UE, and including:
receiving a second announcement message sent by second UE, where the second announcement message carries a ranging response code corresponding to a ranging query code included in a first announcement message.

In some examples, the second announcement message is sent by the second UE according to the ranging query code in the first announcement message matching a ranging query filter.

The second announcement message is: the second announcement message protected on basis of a discovery key. Here, the protection includes an integrity protection and/or an encryption protection, and the encryption protection part is customized by the first UE.

In one example, the second announcement message protected on the basis of the discovery key includes: encrypting sensitive information in the second announcement message on the basis of an REK in the discovery key, and/or performing the integrity protection on the second announcement message on the basis of the RIK in the discovery key.

Receiving the second announcement message sent by the second UE includes: receiving the second announcement message sent by the second UE at a PC5 interface.

Receiving the second announcement message sent by the second UE includes: receiving the second announcement message sent by the second UE on the basis of the ranging response filter.

The second announcement message may refer to descriptions of other examples of the disclosure, which will not be repeated here.

It needs to be noted that, it may be understood by those skilled in the art that the methods provided by the examples of the disclosure may be executed individually, or together with some methods in the examples of the disclosure or some methods in the related art.

In some examples, before sending the first announcement message, the method includes:
sending an LTK request carrying an identifier of the first UE to a ranging key management function (RKMF); and
receiving an LTK and LTK ID returned by the RKMF on the basis of the LTK request.

As shown in FIG. 7, an example of the disclosure provides a UE discovery message protection method, executed by first UE, and including:
step S71: an LTK request carrying an identifier of the first UE is sent to an RKMF; and
step S72: an LTK and LTK ID returned by the RKMF on basis of the LTK request are received.

The RKMF may be, but is not limited to, a physical device or a function executed by the physical device, which is not limited here. In one example, the RKMF is located within a network coverage range.

The LTK request carries the identifier of the first UE, and the LTK request is used for requesting the LTK of the first UE and/or the LTK ID corresponding to the LTK.

Step S71 may be: sending the LTK request carrying the identifier of the first UE to the RKMF when the first UE is located within the network coverage range.

Step S72 may be: receiving the LTK and the LTK ID sent by the RKMF on the basis of the LTK request when the first UE is located within the network coverage range.

In this way, in the example of the disclosure, the first UE may obtain the LTK from the RKMF within the network coverage range when it is located within the network coverage range, and this facilitates the subsequent generation of a new discovery key on the basis of the LTK to encrypt the discovery message.

An example of the disclosure provides a UE discovery message protection method which is executed by first UE, and may include: determining a discovery key on the basis of an LTK. The discovery key includes: an REK and/or an RIK.

In one example, determining a KD of the discovery key on the basis of the LTK includes: determining the KD on the basis of the LTK; determining a temporary key (KD-SESS) on the basis of the KD; and determining the REK and/or the RIK in the discovery key on the basis of the KD-SESS.

In one example, determining the KD on the basis of the LTK includes: determining the KD on the basis of the LTK and a nonce.

Determining the temporary key (KD-SESS) on the basis of the KD includes: determining the KD-SESS on the basis of the KD and a nonce.

Determining the REK and/or the RIK in the discovery key on the basis of the KD-SESS includes: determining the REK and/or the RIK in the discovery key on the basis of the KD-SESS and a nonce.

An example of the disclosure provides a UE discovery message protection method which is executed by first UE, and may include: determining a KD on the basis of an LTK. For example, the first UE determines the KD on the basis of the LTK and a nonce.

An example of the disclosure provides a UE discovery message protection method which is executed by first UE, and may include: determining an intermediate key on the basis of an LTK; determining a KD on the basis of the LTK; determining a KD-SESS on the basis of the KD; and determining an REK and/or an RIK in a discovery key on the basis of the KD-SESS. For example, the first UE determines the KD on the basis of the LTK and a nonce; determines the KD-SESS on the basis of the KD and a nonce; and determines the REK and/or the RIK on the basis of the KD-SESS and a nonce.

An example of the disclosure provides a UE discovery message protection method which is executed by first UE, and may include: encrypting a discovery message on the basis of an REK; and/or, performing an integrity protection on a first announcement message on the basis of an RIK. Here, encrypting the discovery message on the basis of the REK includes: encrypting the discovery message on the basis of the REK and a security algorithm indicated by a security algorithm identity.

In this way, in the example of the disclosure, the first UE may generate a discovery key including the REK and/or the RIK on the basis of the LTK obtained from an RKMF; and thus, the first UE may be enabled to encrypt the discovery message on the basis of the REK and/or perform the integrity protection on the first announcement message including the discovery message on the basis of the RIK, reducing the risk of the first announcement message being leaked.

Determining the discovery key on the basis of the LTK includes: determining the discovery key on the basis of the LTK in response to determining that an available key sent by a network device is void.

In the example of the disclosure, any one mode causing the available key to be void may be possible. For example, the available key being void may be, but is not limited to: expiration of a validity duration of the available key.

Here, the network device may be an access network device or a core network device. For example, the network device is a base station or the RKMF.

Here, the available key refers to a key received by the first UE within a network coverage range.

An example of the disclosure provides a UE discovery message protection method which is executed by first UE, and may include: determining a discovery key on the basis of an LTK when an available key sent by a network device is void.

An example of the disclosure provides a UE discovery message protection method which is executed by first UE, and may include: determining a discovery key on the basis of an LTK when an available key sent by a network device is void.

An example of the disclosure provides a UE discovery message protection method which is executed by first UE, and may include: determining a discovery key on the basis of an LTK when the first UE is located outside a network coverage range and an available key sent by a network device is void.

An example of the disclosure provides a UE discovery message protection method which is executed by first UE, and may include: determining a discovery key on the basis of an LTK when the first UE is located outside a network coverage range and a validity duration of an available key sent by a network device expires.

It needs to be noted that, it may be understood by those skilled in the art that the methods provided by the examples of the disclosure may be executed individually, or together with some methods in the examples of the disclosure or some methods in the related art.

As shown in FIG. 8, an example of the disclosure provides a UE discovery message protection method, executed by first UE, and including:

Step S81: a second announcement message sent by second UE is received, where the second announcement message carries a ranging response code corresponding to a ranging query code included in the second announcement message.

The ranging response code may be used for indicating that the second UE receives a first announcement message. In one possible embodiment, the first announcement message may be a first announcement message as in other examples of the disclosure, or may be other types of first announcement messages, which is not limited by the examples of the disclosure.

The second announcement message is: the second announcement message protected on basis of a discovery key. Here, the protection includes an integrity protection and/or an encryption protection, and the encryption protection part is customized by the first UE.

In one example, the second announcement message protected on the basis of the discovery key includes: encrypting sensitive information in the second announcement message on the basis of an REK in the discovery key, and/or performing the integrity protection on the second announcement message on the basis of an RIK in the discovery key. Here, the second announcement message protected on the basis of the discovery key is a second announcement message encrypted on the basis of the discovery key.

An example of the disclosure provides a UE discovery message protection method which is executed by first UE, and includes: performing an integrity verification and/or decryption on a second announcement message on the basis of a discovery key. Here, performing the integrity verification and/or decryption on the second announcement message on the basis of the discovery key includes: verifying integrity of the second announcement message on the basis of an RIK in the discovery key; and/or decrypting sensitive information in the second announcement message on the basis of an REK in the discovery key.

Step S81 includes: monitoring the second announcement message sent by second UE at a PC5 interface, where the second announcement message carries a ranging response code corresponding to a ranging query code.

An example of the disclosure provides a UE discovery message protection method which is executed by first UE, and may include: monitoring a second announcement message sent by second UE at a PC5 interface. Here, the first UE is located outside a network coverage range.

A ranging response filter is configured in the first UE, where the ranging response filter is used for matching a ranging response code.

An example of the disclosure provides a UE discovery message protection method which is executed by first UE, and includes: receiving a second announcement message sent by second UE on the basis of a ranging response filter.

For example, the first UE, using the locally configured ranging response filter, monitors the second announcement message sent by the second UE at a PC5 interface to obtain the second announcement message corresponding to a ranging response code matching the ranging response filter.

In this way, in the example of the disclosure, the first UE may also receive the second announcement message sent by the second UE, the second announcement message carries the ranging response code corresponding to a ranging query code, and this enables the first UE to accurately know whether the second UE receives the first announcement message.

It needs to be noted that, it may be understood by those skilled in the art that the method provided by the example of the disclosure may be executed individually, or together with some methods in the examples of the disclosure or some methods in the related art.

A following UE discovery message protection method, which is executed by second UE, is similar to the above description of the UE discovery message protection method executed by the first UE; and for technical details not disclosed in the example of the UE discovery message protection method executed by the second UE, please refer to the description of the example of the UE discovery message protection method executed by the first UE, which will not be described in detail here.

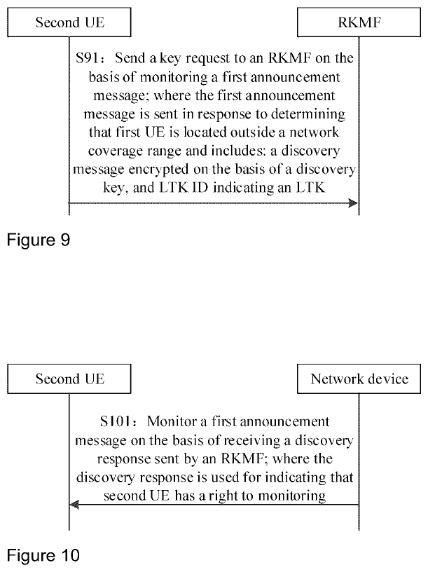

As shown in FIG. 9, an example of the disclosure provides a UE discovery message protection method, executed by second UE, and including:
step S91: a key request is sent to an RKMF on the basis of monitoring a first announcement message; where the first announcement message is sent in response to determining that first UE is located outside a network coverage range and includes: a discovery message encrypted on the basis of a discovery key, and LTK ID indicating an LTK;
where the discovery key is determined by the first UE on the basis of the LTK received in response to determining being within the network coverage range; where the key request includes: the LTK ID; and the key request is used for requesting the discovery key or requesting to generate a KD of the discovery key.

The key request is used for requesting the discovery key determined by the LTK corresponding to the LTK ID or for requesting to generate the KD of the discovery key.

In some examples of the disclosure, the first announcement message is the first announcement message in step S61; the discovery message and the discovery key are the discovery message and the discovery key in step S61 respectively; the LTK ID is the LTK ID in step S61; and the KD is the KD in step S61.

For example, the first announcement message includes, but is not limited to, at least one of the following:
a discovery message encrypted on the basis of a discovery key;
LTK ID indicating an LTK;
a security algorithm identity, used for identifying a security algorithm used by the first announcement message;
a ranging query code used for identifying the first announcement message;
a nonce, used for determining the discovery key together with the LTK; or
a time stamp, used for indicating a validity duration of the discovery key.

The nonce may also be used for decrypting the discovery message together with the discovery key.

For example, the discovery message includes, but is not limited to, at least one of the following:
a time stamp, used for indicating a validity duration of the discovery key;
target ranging layer ID, used for indicating target UE that needs ranging; or
ranging requirement information, used for indicating ranging requirements for ranging.

For example, the discovery key includes at least one of the following:
an REK, used for encrypting the discovery message; or
an RIK, used for protecting integrity of the first announcement message.

In one example, the REK is used for encrypting sensitive information in the discovery message.

Monitoring the first announcement message in step S91 includes: monitoring the first announcement message at a PC5 interface.

An example of the disclosure provides a UE discovery message protection method which is executed by second UE, and may include: monitoring a first announcement message at a PC5 interface; and sending a key request to an RKMF on the basis of monitoring the first announcement message at the PC5 interface.

For example, the second UE, within a network coverage range, monitors the first announcement message sent by first UE which is located outside the network coverage range, at the PC5 interface. If the first announcement message is monitored, the key request is sent to the RKMF.

In this way, in the example of the disclosure, it is possible to cause the second UE, after receiving the first announcement message, to request the discovery key determined by an LTK corresponding to LTK ID or to generate a KD of the discovery key on the basis of the LTK ID in the first announcement message; so that it is possible to cause the second UE, located within the network coverage range, to obtain the first announcement message carrying the discovery message sent by the first UE which is located outside the network coverage range, and to decrypt the discovery message on the basis of the obtained discovery key or the discovery key generated on the basis of the KD. In this way, the example of the disclosure may enable the second UE located within the network coverage range to realize the protection of the discovery message under the premise that the second UE obtains the discovery message sent by the first UE outside the network coverage range, that is, the protection of the discovery message in partial network coverage scenarios may be realized, and the user experience may be improved.

Monitoring the first announcement message in step S91 includes: monitoring the first announcement message on the basis of receiving a discovery response sent by the RKMF; where the discovery response is used for indicating that the second UE has a right to monitor the first announcement message.

An example of the disclosure provides a UE discovery message protection method which is executed by second UE, and includes:
receiving a first announcement message, where the first announcement message is sent when first UE is located outside a network coverage range. The first announcement message includes: a discovery message encrypted on the basis of a discovery key, and LTK ID indicating an LTK; where the discovery key is determined on the basis of the LTK received in response to determining that the first UE is located within the network coverage range; and the LTK ID is used for allowing the second UE to determine a key request to request the discovery key or request to generate a KD of the discovery key.

Here, the first announcement message may refer to descriptions of other examples of the disclosure, which will not be repeated here.

As shown in FIG. 10, an example of the disclosure provides a UE discovery message protection method, executed by second UE, and including:
step S101: a first announcement message is monitored on the basis of receiving a discovery response sent by an RKMF; where the discovery response is used for indicating that the second UE has a right to monitoring.

Monitoring the first announcement message in step S101 may be monitoring the first announcement message sent by a network device. For example, the second UE may monitor the first announcement message sent by first UE.

In one example, the discovery response is used for indicating that the second UE has a right to monitor the first announcement message.

In another example, the discovery response is used or indicating that the second UE has a right to monitoring at a PC5 interface.

The discovery response includes, but is not limited to, at least one of the following:
a ranging query filter, used for matching a ranging query code;
a ranging response code corresponding to the ranging query code; or LTK ID.

The discovery response includes: an identifier indicating target UE for monitoring.

The LTK ID is LTK ID of the first UE, and the LTK ID is used for identifying an LTK.

For example, the second UE receives the discovery response sent by the RKMF and may perform monitoring at the PC5 interface on the basis of the discovery response. The second UE may match the ranging query code in the first announcement message on the basis of the ranging query filter to obtain the first announcement message with the ranging query code that matches the ranging query filter.

In one example, before receiving the discovery response, the method includes: sending a discovery request carrying an identifier of the second UE to the RKMF; where the discovery request is used for requesting an authorization for the second UE to perform monitoring.

An example of the disclosure provides a UE discovery message protection method which is executed by second UE, and may include: sending a discovery request carrying an identifier of the second UE to an RKMF, where the discovery request is used for requesting an authorization for the second UE to perform monitoring.

In one example, the discovery request is used for requesting an authorization for the second UE to monitor a first announcement message.

In another example, the discovery request is used for requesting an authorization for the second UE to perform monitoring at a PC5 interface.

In this way, in the example of the disclosure, the second UE may request the right from the RKMF to perform monitoring at the PC5 interface, and monitor the first announcement message merely when the second UE receives a discovery response with a monitoring right. In this way, on the one hand, a success rate of monitoring the first announcement message may be increased; and on the other hand, the confidentiality of the first announcement message (e.g., a discovery message) may be improved so as to reduce the risk of the discovery message, etc., being monitored by untrusted UE.

In some examples of the disclosure, step S101 may also be: monitoring the first announcement message at the PC5 interface on the basis of the second UE determining that it has the right to perform monitoring at the PC5 interface. In this way, in the example of the disclosure, as long as the second UE determines that it has the monitoring right at the PC5 interface, monitoring may be performed at the PC5 interface.

It needs to be noted that, it may be understood by those skilled in the art that the method provided by the example of the disclosure may be executed individually, or together with some methods in the examples of the disclosure or some methods in the related art.

In some examples, after first UE sends a key request to the RKMF, the method may include: receiving a discovery key sent by the RKMF on the basis of the RKMF or generating a KD of the discovery key.

In some examples of the disclosure, the key request is the key request in step S91. For example, the key request includes: LTK ID.

In some other examples, the key request also includes: a nonce. The nonce, together with the LTK ID, is used for allowing the RKMF to determine the discovery key or to generate the KD of the discovery key.

For example, the key request includes: a nonce and the LTK ID obtained from the first announcement message; and the nonce, together with the LTK ID, is used for allowing the RKMF to determine the discovery key or generate the KD of the discovery key.

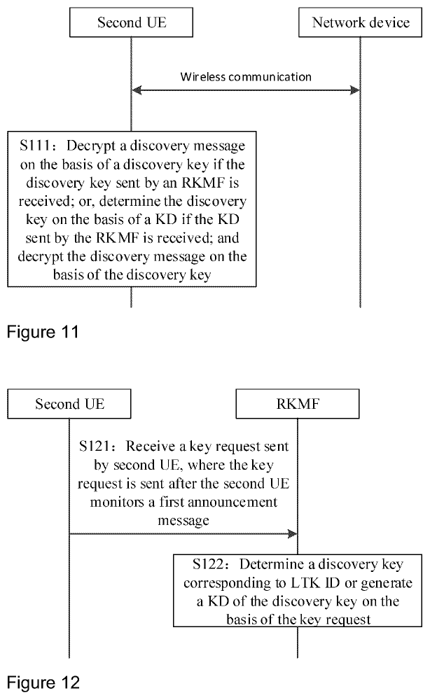

As shown in FIG. 11, an example of the disclosure provides a UE discovery message protection method, executed by second UE, and including:

Step S111: if a discovery key sent by an RKMF is received, a discovery message is decrypted on the basis of the discovery key; or, if a KD sent by the RKMF is received, the discovery key is determined on the basis of the KD; and the discovery message is decrypted on the basis of the discovery key.

In some examples of the disclosure, the discovery message is the discovery message in step S61; and the discovery key is the discovery key in step S61.

In one example, encrypting the discovery message includes: encrypting sensitive information in the discovery message.

For example, the second UE receives the discovery key sent by the RKMF and, on the basis of the discovery key, performs an integrity verification on the first announcement message and/or decrypts the discovery message.

For example, the second UE receives the intermediate key (KD) sent by the RKMF, then determines a temporary key (KD-SESS) on the basis of the KD and the nonce included in the first announcement message, and determines an REK and/or an RIK in the discovery key on the basis of the KD-SESS.

In this way, in the example of the disclosure, the second UE may decrypt the discovery message with the discovery key obtained by the RKMF; or it may also obtain the KD from the RKFM and decrypt the discovery message by generating the discovery key on the basis of the KD. If the second UE obtains the KD from the RKFM and generates the discovery key on the basis of the KD to decrypt the discovery message, the workload of the RKMF may also be reduced, enabling the RKMF to have more resources to process other services.

In some examples, the method includes: determining whether the first announcement message is integral on the basis of the RIK in the discovery key.

Decrypting the discovery message on the basis of the discovery key includes: decrypting the discovery on the basis of a ranging encryption key (REK) in the discovery key in response to determining that the first announcement message is integral.

An example of the disclosure provides a UE discovery message protection method which is executed by second UE, and may include:
determining whether a first announcement message is integral on the basis of an RIK in a discovery key; and
decrypting a discovery message on the basis of a ranging encryption key (REK) in the discovery key in response to determining that the first announcement message is integral.

An example of the disclosure provides a UE discovery message protection method which is executed by second UE, and may include: discarding a first announcement message in response to determining that the first announcement message is not integral.

For example, the second UE, on the basis of an RIK, performs an integrity verification on the first announcement message. If the integrity verification is successful (i.e., the first announcement message is integral), a discovery message in the first announcement message is obtained, and the discovery message is decrypted on the basis of an REK. If the integrity verification fails (i.e., the first announcement message is not integral), the first announcement message is discarded. Here, if the integrity verification by the second UE fails, monitoring of the announcement message sent by first UE within a preset time range may also be suspended, and the announcement message includes the first announcement message and/or other announcement messages.

In this way, in the example of the disclosure, the second UE may perform the integrity verification on the first announcement message on the basis of the RIK in the discovery key and/or decrypt the discovery message on the basis of the REK in the discovery key, and this allows the protection of the discovery message in partial network coverage scenarios and facilitates ranging by using the decrypted discovery message. The example of the disclosure may decrypt the discovery message on the basis of the REK merely when the first announcement message is integral, so that a more trustworthy discovery message may be obtained.

An example of the disclosure provides a UE discovery message protection method which is executed by second UE, and includes: determining, on the basis of a time stamp and/or a nonce obtained from a first announcement message, whether the first announcement message is an announcement message that is subjected to a replay attack.

Here, the time stamp may be carried in the first announcement message, e.g., may be carried in a discovery message in the first announcement message, or may be carried in the first announcement message but not included in the discovery message.

Here, if the time stamp is included in the discovery message, the second UE obtaining the time stamp and/or the nonce from the first announcement message includes: the second UE verifies the integrity of the first announcement message on the basis of an RIK; and, if the integrity verification is successful, the discovery message is decrypted on the basis of an REK to obtain the time stamp and/or the nonce.

Here, if the time stamp is not included in the discovery message, the second UE may obtain the time stamp and/or the nonce directly from the first announcement message.

For example, the second UE determines that the first announcement message is the announcement message that is subjected to the replay attack on the basis that the current time is not within a validity duration indicated by the time stamp; or, determines that the first announcement message is an announcement message that is not subjected to the replay attack on the basis that the current time is within the validity duration indicated by the time stamp.

For example, the second UE determines that the first announcement message is the announcement message that is subjected to the replay attack on the basis of previously receiving a nonce that is the same as the nonce in the first announcement message; or determines that the first announcement message is the announcement message that is not subjected to the replay attack on the basis of not previously receiving the nonce that is the same as the nonce in the first announcement message.

For example, the second UE determines that the first announcement message is the announcement message that is not subjected to the replay attack on the basis that the current time is within the validity duration indicated by the time stamp and on the basis of not previously receiving the nonce that is the same as the nonce in the first announcement message.

In this way, in the example of the disclosure, the second UE may also determine whether the first announcement message is subjected to the replay attack from the time stamp and/or the nonce obtained from the first announcement message, and thus the protection of the discovery message may be improved.

In some examples of the disclosure, the second UE determines not to send second announcement message if the second UE determines that the first announcement message is not integral or that the first announcement message is the announcement message that is subjected to the replay attack.

It needs to be noted that, it may be understood by those skilled in the art that the method provided by the example of the disclosure may be executed individually, or together with some methods in the examples of the disclosure or some methods in the related art.

An example of the disclosure provides a UE discovery message protection method which is executed by second UE, and includes:
sending a second announcement message, where the second announcement message carries a ranging response code corresponding to a ranging query code included in a first announcement message.

The ranging response code may be used for indicating that the second UE receives the first announcement message.

An example of the disclosure provides a UE discovery protection method which is executed by second UE, and may include: sending a second announcement message at a PC5 interface.

Sending the second announcement message includes: sending, on the basis of a ranging query code in a first announcement message matching a ranging query filter, the second announcement message.

Here, the ranging query filter may be obtained by the second UE from a core network device. For example, the second UE may obtain the ranging query filter from a received discovery response, and a discovery message is sent after an RKMF determines that the second UE has a right to monitoring.

An example of the disclosure provides a UE discovery message protection method which is executed by second UE, and may include: sending, on the basis of a ranging query code in a first announcement message matching a ranging query filter, a second announcement message.

The second announcement message is: a second announcement message encrypted on the basis of a discovery key. Here, the second announcement message encrypted on the basis of the discovery key includes: encrypting sensitive information in the second announcement message on the basis of an REK in the discovery key, and/or performing an integrity protection on the second announcement message on the basis of an RIK in the discovery key.

The above embodiment may specifically refer to the description of a first UE side, which will not be repeated here.

It needs to be noted that, it may be understood by those skilled in the art that the method provided by the example of the disclosure may be executed individually, or together with some methods in the examples of the disclosure or some methods in the related art.

A following UE discovery message protection method, which is executed by an RKMF, is similar to the above description of the UE discovery message protection method executed by the first UE and/or the second UE; and for technical details not disclosed in the example of the UE discovery message protection method executed by the RKMF, please refer to the description of the example of the UE discovery message protection method executed by the first UE and/or the second UE, which will not be described in detail here.

As shown in FIG. 12, an example of the disclosure provides a UE discovery message protection method, executed by an RKMF, and including:
step S121: a key request sent by second UE is received, where the key request is sent after the second UE monitors a first announcement message;
where the first announcement message is sent in response to determining that first UE is located outside a network coverage range and includes: a discovery message encrypted on the basis of a discovery key, and LTK ID indicating an LTK; where the discovery key is determined by the first UE on the basis of the LTK received in response to determining being within the network coverage range; and the key request includes: the LTK ID.

Step S122: the discovery key corresponding to the LTK ID is determined or a KD of the discovery key is generated on the basis of the key request.

In some examples of the disclosure, the first announcement message is the first announcement message in step S61; the discovery message and the discovery key are the discovery message and the discovery key in step S61 respectively; the LTK ID is the LTK ID in step S61; and the KD is the KD in step S61. For example, the discovery key includes: an REK and/or an RIK.

Determining the KD corresponding to the LTK ID on the basis of the key request in step S122 includes: determining the KD on the basis of the LTK corresponding to the LTK ID.

Determining the discovery key corresponding to the LTK ID on the basis of the key request in step S122 includes: determining the KD on the basis of the LTK corresponding to the LTK ID in the key request; determining a temporary key (KD-SESS) on the basis of the KD; and determining the discovery key on the basis of the KD-SESS.

Here, the RKMF includes: the LTK ID, and the LTK corresponding to the LTK ID.

In some examples, the key request includes: a nonce.

Determining the discovery key corresponding to the LTK ID on the basis of the key request includes: determining the discovery key on the basis of the LTK corresponding to the LTK ID and the nonce in the key request.

An example of the disclosure provides a UE discovery message protection method which is executed by an RKMF, and may include: determining an LTK on the basis of LTK ID; and determining a KD on the basis of the LTK and a nonce.

An example of the disclosure provides a UE discovery message protection method which is executed by an RKMF, and may include: determining an LTK on the basis of LTK ID; determining a KD on the basis of the LTK and a nonce; determining a KD-SESS on the basis of the KD and a nonce; and determining an REK and/or an RIK on the basis of the KD-SESS.

In some examples, the key request includes: an identifier of second UE.

Determining the discovery key corresponding to the LTK ID on the basis of the key request includes: determining that the second UE has a right to monitoring on the basis of the identifier of the second UE, and determining the discovery key corresponding to the LTK ID.

An example of the disclosure provides a UE discovery protection method which is executed by an RKMF, and may include: determining that second UE has a right to monitoring on the basis of an identifier of the second UE, and determining a discovery key corresponding to LTK ID.

An example of the disclosure provides a UE discovery protection method which is executed by an RKMF, and may include: determining that second UE has a right to monitor a first announcement message on the basis of an identifier of the second UE, and determining a discovery key corresponding to LTK ID.

An example of the disclosure provides a UE discovery message protection method which is executed by an RKMF, and may include: sending a discovery key or an intermediate key to second UE.

It needs to be noted that, it may be understood by those skilled in the art that the method provided by the example of the disclosure may be executed individually, or together with some methods in the examples of the disclosure or some methods in the related art.

An example of the disclosure provides a UE discovery message protection method which is executed by an RKMF, and may include:
receiving an LTK request sent by first UE, where the LTK request includes an identifier of the first UE; and
sending an LTK corresponding to the identifier of the UE and LTK ID to the first UE.

The LTK request is used for requesting the LTK of the first UE and/or the LTK ID.

An example of the disclosure provides a UE discovery message protection method which is executed by an RKMF, and may include: storing an identifier of first UE, an LTK corresponding to the identifier of the first UE, and LTK ID.

An example of the disclosure provides a UE discovery message protection method which is executed by an RKMF, and may include:
receiving a discovery request sent by second UE, where the discovery request includes: an identifier of the second UE;
determining whether the second UE has a right to monitoring on the basis of the identifier of the second UE; and
sending a discovery response to the second UE in response to determining that the second UE has the right to monitoring; where the discovery response is used for indicating that the second UE has the right to monitor a first announcement message.

In some examples of the disclosure, the discovery request and the discovery response are respectively the discovery request and the discovery response in the above examples.

An example of the disclosure provides a UE discovery message protection method which is executed by an RKMF, and may include:
receiving a discovery request sent by second UE, where the discovery request includes: an identifier of the second UE;
determining whether the second UE has a right to monitor a first announcement message on the basis of the identifier of the second UE; and sending a discovery response to the second UE in response to
determining that the second UE has the right to monitor the first announcement message; where the discovery response is used for indicating that the second UE has the right to monitor the first announcement message.

The configuration information may be determined by an application layer.

Determining whether the second UE has the right to monitoring includes: determining whether the second UE has the right to monitoring on the basis of the identifier and configuration information of the second UE; where the configuration information includes: a monitoring right corresponding to each piece of second UE.

An example of the disclosure provides a UE discovery message protection method which is executed by an RKMF, and may include: determining whether second UE has a right to monitoring on the basis of an identifier and configuration information of the second UE.

The configuration information includes: an identifier of each piece of second UE, and a monitoring right of each piece of second UE. The monitoring right includes: having the right to monitoring, or not having the right to monitoring.

For example, the RKMF stores the configuration information. The configuration information includes: an identifier of at least one piece of second UE, and a monitoring right of the second UE corresponding to the identifier of the second UE. The RKMF may query the configuration information on the basis of the identifier of the second UE to determine the monitoring right corresponding to the identifier of the second UE.

The configuration information includes: an identifier of each piece of second UE, and a monitoring right of each piece of second UE for monitoring each piece of first UE. The monitoring right includes: having the right to monitor at least one piece of first UE, or not having the right to monitor at least one piece of first UE.

For example, the RKMF stores the configuration information. The configuration information includes: an identifier of at least one piece of second UE, and a monitoring right of the second UE for monitoring at least one piece of first UE. The RKMF may query the configuration information on the basis of the second UE to determine the monitoring right of the second UE corresponding to the identifier of the second UE for monitoring the first UE.

In one example, the monitoring right of the second UE included in the configuration information includes: a monitoring right of the second UE at the PC5 interface. For example, the monitoring right of the second UE included in the configuration information includes: the second UE, at the PC5 interface, has the right to monitor the announcement message of the first UE; or the second UE, at the PC5 interface, does not have the right to monitor the announcement message of the first UE.

In this way, in the example of the disclosure, the RKMF may determine whether the second UE has the right to monitoring on the basis of the discovery request sent by the second UE, and on the basis of the identifier of the second UE in the discovery request and the configured configuration information; and send a discovery response indicating that the second UE has the right to monitoring to the second UE when the second UE has the right to monitoring. This allows the second UE to monitor the first announcement message merely when the conditions for the right to monitoring are met.

The above embodiment may specifically refer to the description of the first UE side, which will not be repeated here.

It needs to be noted that, it may be understood by those skilled in the art that the method provided by the example of the disclosure may be executed individually, or together with some methods in the examples of the disclosure or some methods in the related art.

To further explain any examples of the disclosure, a plurality of specific embodiments are provided below.

### Example 1

Firstly, application scenarios of the UE discovery message protection method are explained as follows: the UE discovery message protection method may be introduced in the scenario of the secure ranging discovery process under the 5G network coverage; and the security algorithm identifier may be set as described in 3GPP TS 33.501 in the UE discovery message protection method. Here, the first UE leaving the 5G network coverage range has been pre-configured or provided with information about discoverable target UE by the network device. Here, in order to protect the communication between the UE and the RKMF, the UE and the RKMF are expected to support security conditions and steps in Clause 5.2.5 of 3GPP TS 33.503. Here, the second UE supports the security algorithm used by the first UE.

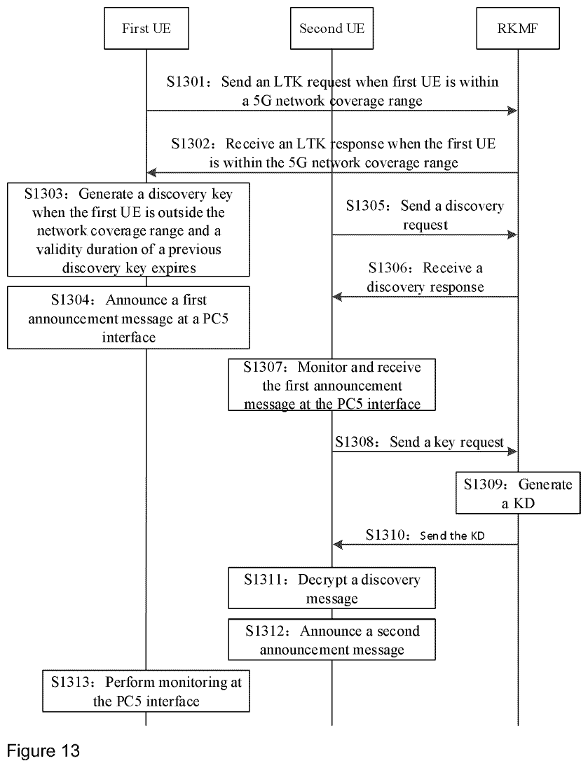

As shown in FIG. 13, an example of the disclosure provides a UE discovery message protection method, executed by a communication device. The communication device includes first UE, second UE and an RKMF. The method includes:
step S1301: an LTK request is sent when the first UE is within a 5G network coverage range.

In an optional example, the first UE, within the 5G network coverage range, sends the LTK request carrying an identifier of the first UE to obtain an LTK from the RKMF.

Step S1302: an LTK response is received when the first UE is within the 5G network coverage range.

In an optional example, before step S132, the RKMF generates and sends the LTK and the LTK ID of the first UE after receiving the LTK request.

In an optional example, the first UE receives the LTK response sent by the RKMF when the first UE is within the 5G network coverage range; where the LTK response includes: the LTK corresponding to the identifier of the first UE and LTK ID.

Step S1303: the discovery key is generated when the first UE is outside the network coverage range and a validity duration of a previous discovery key expires.

Here, the previous discovery key is an available key sent by the network device in the above example.

In an optional example, the first UE generates a new discovery key when the first UE is out of the network coverage range and it is determined that the previous discovery key expires. For example, the first UE may, on the basis of a key generation function (KDF) specified in Appendix B of TS 33.220, first generate a KD on the basis of the LTK; then generate a KD-SESS on the basis of the KD; and finally derive an REK and an RIK on the basis of the KD, so as to protect the encryption and integrity of the message.

Step S1304: the first announcement message is announced at the PC5 interface.

The first announcement message includes: a ranging query code, a time stamp, target ranging layer ID, and ranging requirement information. The first announcement message further includes: LTK ID and a nonce for deriving a discovery key. Here, at least one of the ranging query code, the target ranging layer ID, or the ranging requirement information may be the information in the discovery message in the above example.

In an optional example, the first UE first encrypts the sensitive information in the first announcement message by utilizing the REK; and then performs an integrity protection on the encrypted sensitive information, the LTK ID of the first UE, and the nonce used for deriving the discovery key by utilizing the RIK so as to obtain the first announcement message; and the first UE announces the first announcement message at the PC5 interface. The sensitive information is at least a part of information in the discovery message.

Step S1305: a discovery request is sent.

In an optional example, the second UE sends a discovery request carrying the identifier of the second UE to the RKMF to request monitoring at the PC5 interface.

Step S1306: a discovery response is received.

In an optional example, the RKMF authorizes the second UE to perform monitoring according to the discovery request sent by the second UE on the basis of the configuration information. The RKMF sends the discovery response to UE to indicate that the second UE has a right to monitoring. Here, the configuration information includes: a service configuration file. The service configuration file is defined by an application layer.

In an optional example, the second UE receives a discovery response, where the discovery response includes information of a set of target UE, a corresponding ranging query filter, a corresponding ranging response code, and LTK ID of the first UE. Here, the information of the set of target UE includes: identifiers of the set of target UE. In one example, the target UE includes the first UE.

Step S1307: the first announcement message is monitored and received at the PC5 interface.

In an optional example, the second UE monitors the first announcement message at the PC5 interface by utilizing the information of the set of target UE.

Step S1308: a key request is sent.

In an optional example, the second UE, within the 5G network coverage range, after receiving the first announcement message from the first UE, sends the LTK ID including the first UE and a nonce for generating the KD to the RKMF. Here, the key request includes the LTK ID of the first UE and the nonce.

Step S1309: the KD is generated.

In an optional example, the RKMF determines whether the second UE has the right to monitor the first UE on the basis of the service configuration file; if it is determined that the second UE does not have the right to monitor the first UE, the discovery process is terminated; and if it is determined that the second UE has the right to monitor the first UE, the RKMF determines the KD on the basis of the LTK of the first UE and the nonce.

Step S1310: the KD is sent.

In an optional example, the RKMF sends the newly generated KD to the second UE.

Step S1311: the discovery message is decrypted.

In an optional example, the second UE generates a KD-SESS on the basis of the received KD, and generates an REK and an RIK on the basis of the KD-SESS and the nonce. The second UE verifies the integrity of the first announcement message on the basis of the RIK. If the integrity verification fails, the UE2 suspends the first announcement message of the first UE. Otherwise, the second UE decrypts the discovery message on the basis of the REK.

In an optional example, the second UE may check the time stamp and the nonce of the integrity protection. If the time stamp and/or the nonce indicate/indicates the presence of a replay attack, the second UE suspends the announcement message of the first UE.

Here, the second UE suspending the announcement message of the first UE may mean: the second UE suspends monitoring the announcement message of the first UE.

Step S1312: a second announcement message is announced.

In an optional example, the second UE, if it determines that the ranging query code of the first UE matches the ranging query filter of the second UE, formulates the second announcement message including the corresponding ranging response code, and announces the second announcement message at the PC5 interface. The second UE encrypts the sensitive information in the second announcement message by using the REK and then protects the integrity of the entire second announcement message by using the RIK.

Step S1313: monitoring is performed at the PC5 interface.

In an optional example, the first UE performs monitoring at the PC5 interface by using a locally configured ranging response filter, and verifies and decrypts the second announcement message from the second UE, and the second announcement message includes the ranging response code that matches the ranging response filter.

### Example 2

An example of the disclosure provides a key derivation method.

Step A: a KD is calculated on the basis of an LTK, and an input for a KDF is to be constituted by using the following parameters:
FC=0×58;
PO=Nonce_1;
L0=length of Nonce_1 (i.e. 0×00 0×03);
P1=Nonce_2;
L1=length of Nonce_2 (i.e. 0×00 0×10);
P2=Nonce_3;
L2=length of Nonce_3 (i.e. 0×00 0×10).

Here, an input key is to be a 256-bit LTK.

Step B: a KD-SESS is calculated on the basis of the KD, and the input for the KDF is to be constituted by using the following parameters:
FC=0×5E;
P0=Nonce_4;
L0=length of Nonce_4 (i.e. 0×00 0×10);
P1=Nonce_5;
L1=length of Nonce_5 (i.e. 0×00 0×10).

Here, the input key is to be a 256-bit KD.

Step C: an RIK or an REK is calculated on the basis of the KD-SESS, and the input for the KDF is to be formed by using the following parameters:
FC=0×5B;
P0=0×00 if REK is being derived or 0×01 if RIK is being derived;
L0=length of P0 (i.e. 0×00 0×01);
P1=algorithm identity;
L1=length of algorithm identity (i.e. 0×00 0×01);
NOTE: Void.

Here, the input key is to be a 256-bit KD-SESS.

Here, for the input key of a length being n bits, n is less than or equal to 256. The n lowest valid bits of the 256 bits output by the KDF are to be used as the input key.

It needs to be noted that, it may be understood by those skilled in the art that the method provided by the example of the disclosure may be executed individually, or together with some methods in the examples of the disclosure or some methods in the related art.

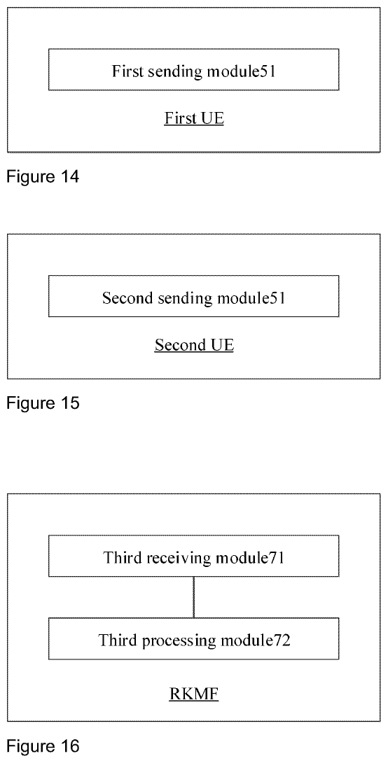

As shown in FIG. 14, an example of the disclosure provides a UE discovery message protection apparatus, applied to first UE, and including:
a first sending module 51, configured to send a first announcement message in response to determining that the first UE is located outside a network coverage range, where the first announcement message includes: a discovery message encrypted on the basis of a discovery key, and LTK ID indicating an LTK;
where the discovery key is determined on the basis of the LTK received in response to determining that the first UE is located within the network coverage range, and the LTK ID is used for allowing second UE to determine a key request to request the discovery key or request to generate an intermediate key (KD) of the discovery key.

An example of the disclosure provides a UE discovery message protection apparatus, applied to first UE, and including: a first sending module 51 configured to send a first announcement message on the basis of a proximity communication (PC5) interface.

An example of the disclosure provides a UE discovery message protection apparatus, applied to first UE, and including:
a first sending module 51, configured to send an LTK request carrying an identifier of the first UE to an RKMF; and
a first receiving module, configured to receive an LTK and LTK ID returned by the RKMF on the basis of the LTK request.

An example of the disclosure provides a UE discovery message protection apparatus applied to first UE, and including: a first processing module, configured to determine a discovery key on the basis of an LTK.

In some examples, the discovery key includes at least one of the following:
an REK, used for encrypting the discovery message; or
an RIK, used for protecting integrity of the first announcement message.

An example of the disclosure provides a UE discovery message protection apparatus, applied to first UE, and including: a first processing module, configured to determine a discovery key on the basis of an LTK if an available key sent by a network device is void.

An example of the disclosure provides a UE discovery message protection apparatus, applied to first UE, and including: a first processing module, configured to determine a discovery key on the basis of an LTK if a validity duration of an available key sent by a network device expires.

An example of the disclosure provides a UE discovery message protection apparatus, applied to first UE, and including: a first processing module, configured to determine a KD on the basis of an LTK.

An example of the disclosure provides a UE discovery message protection apparatus, applied to first UE, and including: a first processing module, configured to determine a KD on the basis of an LTK and a nonce.

An example of the disclosure provides a UE discovery message protection apparatus, applied to first UE, and including: a first processing module, configured to determine a KD on the basis of an LTK; determine a KD-SESS on the basis of the KD; and determine an REK and/or an RIK in a discovery key on the basis of the KD-SESS.

An example of the disclosure provides a UE discovery message protection apparatus, applied to first UE, and including: a first processing module, configured to determine a KD on the basis of an LTK and a nonce; determine a KD-SESS on the basis of the KD and a nonce; and determine an REK and/or an RIK in a discovery key on the basis of the KD-SESS and a nonce.

In some examples, the first announcement message further includes at least one of the following:
a security algorithm identity, used for identifying a security algorithm used by the first announcement message;
a ranging query code used for identifying the first announcement message;
a nonce, used for determining the discovery key together with the LTK; or
a time stamp, used for indicating a validity duration of the discovery key.

In some examples, the discovery message includes at least one of the following:
target ranging layer ID, used for indicating target UE that needs ranging; or
ranging requirement information, used for indicating ranging requirements for ranging.

An example of the disclosure provides a UE discovery message protection apparatus, applied to first UE, and including: a first receiving module, configured to receive a second announcement message sent by second UE, where the second announcement message carries a ranging response code corresponding to a ranging query code.

An example of the disclosure provides a UE discovery message protection apparatus, applied to first UE, and including: a first receiving module, configured to receive a second announcement message sent by second UE, where the second announcement message carries a ranging response code corresponding to a ranging query code included in a first announcement message.

An example of the disclosure provides a UE discovery message protection apparatus, applied to first UE, and including: a first receiving module, configured to receive a second announcement message sent by second UE on the basis of a ranging response filter.

In some examples, the second announcement message is: the second announcement message protected on the basis of the discovery key.

An example of the disclosure provides a UE discovery message protection apparatus, applied to first UE, and including: a first processing module, configured to perform an integrity verification and/or decryption on a second announcement message on the basis of a discovery key.

An example of the disclosure provides a UE discovery message protection apparatus, applied to second UE, and including:
a second receiving module, configured to receive a first announcement message. The first announcement message is sent in response to determining that first UE is located outside a network coverage range and includes: a discovery message encrypted on the basis of a discovery key, and LTK ID indicating an LTK; where the discovery key is determined on the basis of the LTK received in response to determining that the first UE is located within the network coverage range; and the LTK ID is used for allowing the second UE to determine a key request to request the discovery key or request to generate a KD of the discovery key.

As shown in FIG. 15, an example of the disclosure provides a UE discovery message protection apparatus, applied to second UE, and including:
a second sending module 61, configured to send a key request to an RKMF on the basis of monitoring a first announcement message; where the first announcement message is sent in response to determining that first UE is located outside a network coverage range and includes: a discovery message encrypted on the basis of a discovery key, and LTK ID indicating an LTK;
where the discovery key is determined by the first UE on the basis of the LTK received in response to determining being within the network coverage range; where the key request includes: the LTK ID; and the key request is used for requesting the discovery key or requesting to generate a KD of the discovery key.

An example of the disclosure provides a UE discovery message protection apparatus, applied to second UE, and including: a second receiving module, configured to monitor a first announcement message on the basis of receiving a discovery response sent by an RKMF; where the discovery response is used for indicating that the second UE has a right to monitoring.

An example of the disclosure provides a UE discovery message protection apparatus, applied to second UE, and including: a second receiving module, configured to monitor a first announcement message at a proximity communication (PC5) interface.

An example of the disclosure provides a UE discovery message protection apparatus, applied to second UE, and including: a second sending module 61, configured to send a discovery request carrying an identifier of the second UE to an RKMF, where the discovery request is used for requesting an authorization for the second UE to perform monitoring.

In some examples, the discovery response includes at least one of the following:
a ranging query filter, used for matching a ranging query code;
a ranging response code corresponding to the ranging query code; or
LTK ID.

An example of the disclosure provides a UE discovery message protection
apparatus, applied to second UE, and including: a second processing module, configured to decrypt a discovery message on the basis of a discovery key if the discovery key sent by an RKMF is received; or
a second processing module, configured to determine the discovery key on the basis of a KD if the KD sent by the RKMF is received, and decrypt the discovery message on the basis of the discovery key.

An example of the disclosure provides a UE discovery message protection apparatus, applied to second UE, and including: a second processing module, configured to determine whether a first announcement message is integral on the basis of an RIK in a discovery key; or
a second processing module, configured to decrypt a discovery message on the basis of an REK in the discovery key in response to determining that the first announcement message is integral.

In some examples, the key request includes: a nonce obtained from the first announcement message; and the nonce, together with the LTK ID, is used for allowing the RKMF to determine the discovery key or generate the KD of the discovery key.

An example of the disclosure provides UE discovery message protection apparatus, applied to second UE, and including: a second processing module, configured to determine, on the basis of a time stamp and/or a nonce obtained from a first announcement message, whether the first announcement message is an announcement message that is subjected to a replay attack.

An example of the disclosure provides a UE discovery message protection apparatus, applied to second UE, and including: a second sending module, configured to send a second announcement message, where the second announcement message carries a ranging response code corresponding to a ranging query code included in a first announcement message.

An example of the disclosure provides a UE discovery message protection apparatus, applied to second UE, and including: a second sending module, configured to send, on the basis of a ranging query code in a first announcement message matching a ranging query filter, a second announcement message.

In some examples, the discovery message includes at least one of the following:
target ranging layer ID, used for indicating target UE that needs ranging; or
ranging requirement information, used for indicating ranging requirements for ranging.

As shown in FIG. 16, an example of the disclosure provides a UE discovery message protection apparatus, applied to an RKMF, and including:
a third receiving module 71, configured to receive a key request sent by second UE, where the key request is sent after the second UE monitors a first announcement message; where the first announcement message is sent in response to determining that first UE is located outside a network coverage range and includes: a discovery message encrypted on the basis of a discovery key, and LTK ID indicating an LTK; where the discovery key is determined by the first UE on the basis of the LTK received in response to determining being within the network coverage range; and the key request includes: the LTK ID; and
a third processing module 72, configured to determine the discovery key corresponding to the LTK ID or generate an intermediate key of the discovery key on the basis of the key request.

An example of the disclosure provides a UE discovery message protection apparatus, applied to an RKMF, and including: a third sending module, configured to send a discovery key or an intermediate key to second UE.

An example of the disclosure provides a UE discovery message protection apparatus, applied to an RKMF, and including: a third receiving module 71, configured to receive an LTK request sent by first UE, where the LTK request includes an identifier of the first UE; and
a third sending module, configured to send an LTK corresponding to the identifier of the first UE and LTK ID to the first UE.

An example of the disclosure provides a UE discovery message protection apparatus, applied to an RKMF, and including: a third receiving module 71, configured to receive a discovery request sent by second UE, where the discovery request includes an identifier of the second UE;
a third processing module 72, configured to determine whether the second UE has a right to monitoring on the basis of the identifier of the second UE; and
a third sending module, configured to send a discovery response to the second UE in response to determining that the second UE has the right to monitoring; where the discovery response is used for indicating that the second UE has the right to monitor a first announcement message.

An example of the disclosure provides a UE discovery message protection apparatus, applied to an RKMF, and including: a third processing module 72, configured to determine whether second UE has a right to monitoring on the basis of an identifier and configuration information of the second UE. The configuration information includes: a monitoring right corresponding to each piece of second UE.

An example of the disclosure provides a UE discovery message protection apparatus, applied to an RKMF, and including: a third processing module 72, configured to determine an intermediate key (KD) on the basis of an LTK corresponding to LTK ID in a key request.

In some examples, the key request includes: a nonce.

The third processing module 72 is configured to determine the discovery key on the basis of the LTK corresponding to the LTK ID and the nonce in the key request.

An example of the disclosure provides a UE discovery message protection apparatus, applied to an RKMF, and including: a third processing module 72, configured to determine an intermediate key (KD) on the basis of an LTK corresponding to LTK ID and a nonce in a key request.

An example of the disclosure provides a UE discovery message protection apparatus, applied to an RKMF, and including: a third processing module 72, configured to determine a KD on the basis of an LTK corresponding to LTK ID in a key request; determine a KD-SESS on the basis of the KD; and determine a discovery key on the basis of the KD-SESS.

An example of the disclosure provides a UE discovery message protection apparatus, applied to an RKMF, and including: a third processing module 72, configured to determine a KD on the basis of an LTK corresponding to LTK ID and a nonce in a key request; determine a KD-SESS on the basis of the KD and a nonce; and determine a discovery key on the basis of the KD-SESS and a nonce.

In some examples, the discovery key includes at least one of the following:
an REK, used for encrypting the discovery message; or
an RIK, used for protecting integrity of the first announcement message.

In some examples, the key request includes: an identifier of second UE.

The third processing module 72, is configured to determine that the second UE has a right to monitoring on the basis of the identifier of the second UE, and determine the discovery key corresponding to LTK ID.

It needs to be noted that, it may be understood by those skilled in the art that the apparatus provided by the example of the disclosure may be executed individually, or together with some apparatuses in the examples of the disclosure or some apparatuses in the related art.

As for the apparatus in the above example, a specific mode in which each module performs operations has been described in detail in the examples of the method, which will not be described in detail here.

An example of the disclosure provides a communication device, including: a processor; and
a memory configured to store executable instructions for the processor;
where the processor is configured to: implement a positioning method of any example of the disclosure when running the executable instructions.

In one example, the communication device may include, but is not limited to, at least one of: a core network device, an access network device, or UE. The UE may be the first UE or the second UE in the above examples. The core network device may be the RKMF in the above examples.

The processor may include various types of storage media. The storage media are non-temporary computer storage media, and can continue to memorize information stored after the user equipment is powered down.

The processor may be connected with the memory via a bus and the like, and is configured to read an executable program stored on the memory, such as at least one of the methods shown in FIG. 6 to FIG. 13.

An example of the disclosure further provides a computer storage medium which stores a computer executable program, and the executable program implements the positioning method of any example of the disclosure in response to determining being executed by a processor, for example, at least one of the methods as shown in FIG. 6 to FIG. 13.

As for the apparatuses or storage media in the above examples, a specific mode in which each module performs operations has been described in detail in the examples of the method, which will not be described in detail here.

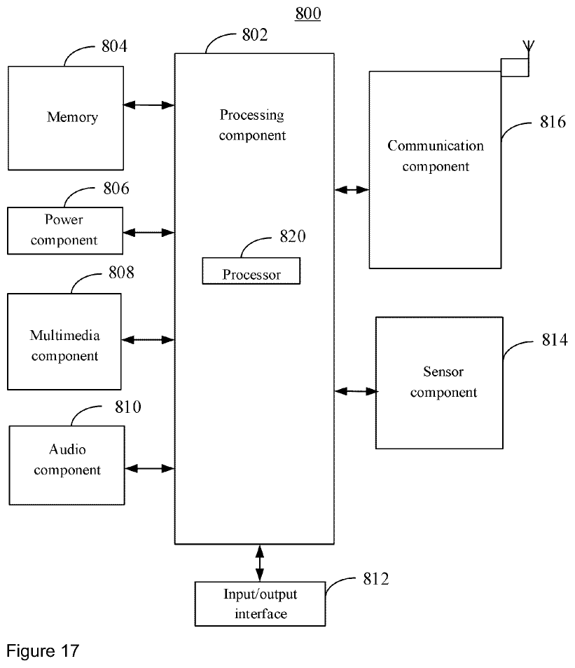

FIG. 17 is a block diagram of user equipment 800 illustrated according to an example. For example, the user equipment 800 may be a mobile phone, a computer, digital broadcasting user equipment, a messaging device, a game console, a tablet device, a medical device, a fitness device, a personal digital assistant, etc.

Referring to FIG. 17, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls an overall operation of the user equipment 800, such as operations associated with display, a telephone call, a data communication, a camera operation, and a recording operation. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the user equipment 800. Examples of these data include instructions for any application or method operating on the user equipment 800, contact data, phonebook data, messages, pictures, videos, etc. The memory 804 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 806 provides power for various components of the user equipment 800. The power component 806 may include a power management system, one or more power sources and other components associated with generating, managing and distributing power for the user equipment 800.

The multimedia component 808 includes a screen providing an output interface between the user equipment 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense a touch, sliding and gestures on the touch panel. The touch sensor cannot merely sense the boundary of the touch or sliding operation, but also detect the duration and pressure related to the touch or sliding operation. In some examples, the multimedia component 808 includes a front camera and/or a rear camera. When the user equipment 800 is in an operation mode, such as a shooting mode or a video mode, the front camera and/or the rear camera can receive external multimedia data. Each front camera and rear camera may be a fixed optical lens system or have a focal length and optical zoom capability.

The audio component 810 is configured to output and/or input audio signals. For example, the audio component 810 includes a microphone (MIC) configured to receive an external audio signal when the user equipment 800 is in the operation mode, such as a call mode, a recording mode, and a speech recognition mode. The received audio signal may be further stored in the memory 804 or transmitted via the communication component 816. In some examples, the audio component 810 also includes a speaker for outputting an audio signal.

The I/O interface 812 provides an interface between the processing component 802 and a peripheral interface module which may be a keyboard, a click wheel, a button, etc. These buttons may include but are not limited to: a home button, a volume button, a start button and a lock button.

The sensor component 814 includes one or more sensors for providing state evaluation of various aspects of the user equipment 800. For example, the sensor component 814 may detect a switch-on/switch-off state of the user equipment 800, the relative positioning of components, such as the components being a display and a keypad of the user equipment 800, and the sensor component 814 may also detect a change in the position of the user equipment 800 or of a component of the user equipment 800, the presence or absence of user contact with the user equipment 800, an orientation or acceleration/deceleration of the user equipment 800, and a change in temperature of the user equipment 800. The sensor component 814 may include a proximity sensor configured to detect the presence of nearby objects without any physical contact. The sensor component 814 may further include an optical sensor, such as a CMOS or CCD image sensor, for use in imaging applications. In some examples, the sensor component 814 may further include an acceleration sensor, a gyroscope sensor, a magnetic sensor, a pressure sensor, or a temperature sensor.

The communication component 816 is configured to facilitate wired or wireless communication between the user equipment 800 and other devices. The user equipment 800 may access a wireless network based on a communication standard, such as Wi-Fi, 4G or 5G, or their combination. In an example, the communication component 816 receives a broadcast signal or broadcast-related information from an external broadcast management system via a broadcast channel. In an example, the communication component 816 further includes a near field communication (NFC) module to facilitate short-range communication. For example, the NFC module may be implemented based on a radio frequency identification (RFID) technology, an infrared data association (IrDA) technology, an ultra wideband (UWB) technology, a Bluetooth (BT) technology and other technologies.

In an example, the user equipment 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the above methods.

In an example, a non-temporary computer-readable storage medium including instructions, such as the memory 804 including instructions, which can be executed by the processor 820 of the user equipment 800 to complete the above method, is further provided. For example, the non-temporary computer-readable storage medium may be an ROM, a random access memory (RAM), a CD-ROM, a magnetic tape, a floppy disk, an optical data storage device, etc.

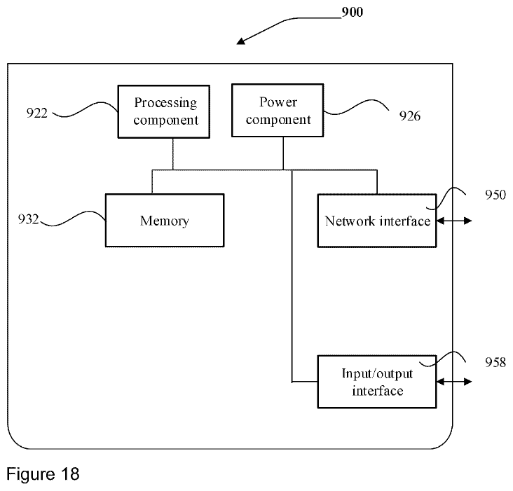

As shown in FIG. 18, an example of the disclosure shows a structure of a base station. For example, the base station 900 may be provided as a network side device. Referring to FIG. 18, the base station 900 includes a processing component 922, which further includes one or more processors, and a memory resource represented by a memory 932 for storing instructions, such as applications, that can be executed by the processing component 922. The applications stored in the memory 932 may include one or more modules each corresponding to a set of instructions. In addition, the processing component 922 is configured to execute instructions to execute any method applied to the base station above, such as the methods shown in FIG. 4 to FIG. 10.

The base station 900 may further include a power component 926 configured to perform power management of the base station 900, a wired or wireless network interface 950 configured to connect the base station 900 to the network, and an input/output (I/O) interface 958. The base station 900 can operate an operating system based on the memory 932, such as Windows Server™, Mac OS X™, Unix™, Linux™, FreeBSD™, or the like.

Other examples of the disclosure will be apparent to those skilled in the art from consideration of the specification and practice of the disclosure here. The disclosure is intended to cover any variations, uses, or adaptations of the disclosure that follow the general principles of the disclosure and include common knowledge or customary technical means in the technical field not disclosed here. The specification and examples are considered as examples merely, with a true scope and spirit of the disclosure being indicated by the following claims.

It will be appreciated that the disclosure is not limited to the exact construction that has been described above and illustrated in the accompanying drawings, and that various modifications and changes may be made without departing from its scope. The scope of the disclosure is merely limited by the appended claims.

Embodiment 1. A UE discovery message protection method, executed by a first user equipment (UE), and comprising:
sending a first announcement message in response to determining that the first UE is located outside a network coverage range, wherein the first announcement message comprises: a discovery message encrypted based on a discovery key, and long-term key (LTK) identifier information (ID) indicating an LTK;
wherein the discovery key is determined based on the LTK received in response to determining that the first UE is located within the network coverage range; and the LTK ID is used for allowing a second UE to determine a key request to request the discovery key or request to generate an intermediate key (KD) of the discovery key.

Embodiment 2. The method according to embodiment 1, before sending the first announcement message, comprising:
sending an LTK request carrying an identifier of the first UE to a ranging key management function (RKMF); and
receiving the LTK and the LTK ID returned by the RKMF based on the LTK request.

Embodiment 3. The method according to embodiment 2, comprising:
determining the discovery key based on the LTK; wherein the discovery key comprises at least one of the following:
a ranging encryption key (REK), used for encrypting the discovery message; or
a ranging integrity key (RIK), used for protecting integrity of the first announcement message.

Embodiment 4. The method according to embodiment 3, wherein determining the discovery key based on the LTK comprises:
determining the discovery key based on the LTK in response to determining that an available key sent by a network device is void.

Embodiment 5. The method according to embodiment 3, wherein determining the discovery key based on the LTK comprises:
determining the KD based on the LTK;
determining a temporary key (KD-SESS) based on the KD; and
determining the REK and/or the RIK in the discovery key based on the KD-SESS.

Embodiment 6. The method according to embodiment 5, wherein determining the KD based on the LTK comprises:
determining the KD based on the LTK and a nonce;
determining the temporary key (KD-SESS) based on the KD comprises:
determining the KD-SESS based on the KD and a nonce; and
determining the REK and/or the RIK in the discovery key based on the KD-SESS comprises:
determining the REK and/or the RIK in the discovery key based on the KD-SESS and a nonce.

Embodiment 7. The method according to embodiment 1, wherein sending the first announcement message comprises:
sending the first announcement message based on a proximity communication (PC5) interface.

Embodiment 8. The method according to any one of embodiments 1 to 7, wherein the first announcement message further comprises at least one of the following:
a time stamp, used for indicating a validity duration of the discovery key;
a security algorithm identity, used for identifying a security algorithm used by the first announcement message;
a ranging query code used for identifying the first announcement message; and
a nonce, used for determining the discovery key together with the LTK.

Embodiment 9. The method according to embodiment 1, comprising:
receiving a second announcement message sent by the second UE, wherein the second announcement message carries a ranging response code corresponding to a ranging query code comprised in the first announcement message.

Embodiment 10. The method according to embodiment 9, wherein the second announcement message is: the second announcement message protected based on the discovery key; and
the method further comprises: performing an integrity verification and/or decryption on the second announcement message based on the discovery key.

Embodiment 11. The method according to any one of embodiments 1 to 7, wherein the discovery message comprises at least one of the following:
target ranging layer ID, used for indicating target UE that needs ranging; or
ranging requirement information, used for indicating ranging requirements for ranging.

Embodiment 12. A UE discovery message protection method, executed by a second user equipment (UE), and comprising:
sending a key request to a ranging key management function (RKMF) based on monitoring a first announcement message, wherein the first announcement message is sent in response to determining that a first UE is located outside a network coverage range and comprises: a discovery message encrypted based on a discovery key, and long-term key (LTK) identifier information (ID) indicating an LTK;
wherein the discovery key is determined by the first UE based on the LTK received in response to determining being within the network coverage range; wherein the key request comprises: the LTK ID; and the key request is used for requesting the discovery key or requesting to generate an intermediate key (KD) of the discovery key.

Embodiment 13. The method according to embodiment 12, wherein monitoring the first announcement message comprises:
monitoring the first announcement message based on receiving a discovery response sent by the RKMF; wherein the discovery response is used for indicating that the second UE has a right to monitoring.

Embodiment 14. The method according to embodiment 13, wherein monitoring the first announcement message comprises:
monitoring the first announcement message at a proximity communication (PC5) interface.

Embodiment 15. The method according to embodiment 13, comprising:
sending a discovery request carrying an identifier of the second UE to the RKMF, wherein the sending request is used for requesting an authorization for the second UE to perform monitoring.

Embodiment 16. The method according to embodiment 13, wherein the discovery response comprises at least one of the following:
a ranging query filter, used for matching a ranging query code;
a ranging response code corresponding to the ranging query code; or
the LTK ID.

Embodiment 17. The method according to any one of embodiments 12 to 16, comprising:
decrypting the discovery message based on the discovery key in response to determining that the discovery key sent by the RKMF is received;
or,
determining the discovery key based on the KD in response to determining that the KD sent by the RKMF is received; and decrypting the discovery message based on the discovery key.

Embodiment 18. The method according to embodiment 17, comprising:
determining whether the first announcement message is integral based on a ranging integrity key (RIK) in the discovery key; and
decrypting the discovery message based on the discovery key comprises:
decrypting the discovery message based on a ranging encryption key (REK) in the discovery key in response to determining that the first announcement message is integral.

Embodiment 19. The method according to embodiment 17, wherein the key request comprises: a nonce obtained from the first announcement message; and the nonce, together with the LTK ID, is used for allowing the RKMF to determine the discovery key or generate the KD of the discovery key.

Embodiment 20. The method according to embodiment 18, comprising:
determining whether the first announcement message is an announcement message that is subjected to a replay attack based on a time stamp and/or a nonce obtained from the first announcement message.

Embodiment 21. The method according to embodiment 17, comprising:
sending a second announcement message, wherein the second announcement message carries the ranging response code corresponding to the ranging query code comprised in the first announcement message.

Embodiment 22. The method according to embodiment 21, wherein sending the second announcement message comprises:
sending the second announcement message based on the ranging query code in the first announcement message matching the ranging query filter.

Embodiment 23. The method according to any one of embodiments 12 to 16, wherein the discovery message comprises at least one of the following:
target ranging layer ID, used for indicating target UE that needs ranging; or
ranging requirement information, used for indicating ranging requirements for ranging.

Embodiment 24. A UE discovery message protection method, executed by a ranging key management function (RKMF), and comprising:
receiving a key request sent by a second UE, wherein the key request is sent after the second UE monitors a first announcement message; wherein the first announcement message is sent in response to determining that a first UE is located outside a network coverage range and comprises: a discovery message encrypted based on a discovery key, and long-term key (LTK) identifier information (ID) indicating an LTK; wherein the discovery key is determined by the first UE based on the LTK received in response to determining being within the network coverage range; and the key request comprises: the LTK ID; and
determining the discovery key corresponding to the LTK ID or generating an intermediate key (KD) of the discovery key based on the key request.

Embodiment 25. The method according to embodiment 24, comprising:
sending the discovery key or the KD to the second UE.

Embodiment 26. The method according to embodiment 24, comprising:
receiving an LTK request sent by the first UE, wherein the LTK request comprises an identifier of the first UE; and
sending the LTK corresponding to the identifier of the first UE and the LTK ID to the first UE.

Embodiment 27. The method according to any one of embodiments 24 to 26, comprising:
receiving a discovery request sent by the second UE, wherein the discovery request comprises: an identifier of the second UE;
determining whether the second UE has a right to monitoring based on the identifier of the second UE; and
sending a discovery response to the second UE in response to determining that the second UE has the right to monitoring; wherein the discovery response is used for indicating that the second UE has the right to monitoring.

Embodiment 28. The method according to embodiment 27, wherein determining whether the second UE has the right to monitoring based on the identifier of the second UE comprises:
determining whether the second UE has the right to monitoring based on the identifier and configuration information of the second UE; wherein the configuration information comprises: a monitoring right corresponding to each piece of second UE.

Embodiment 29. The method according to embodiment 25, wherein determining the discovery key corresponding to the LTK ID based on the key request comprises:
determining the intermediate key (KD) based on the LTK corresponding to the LTK ID in the key request;
determining a temporary key (KD-SESS) based on the KD; and
determining the discovery key based on the KD-SESS.

Embodiment 30. The method according to embodiment 29, wherein the discovery key comprises at least one of the following:
a ranging encryption key (REK), used for encrypting the discovery message; or
a ranging integrity key (RIK), used for protecting integrity of the first announcement message.

Embodiment 31. The method according to embodiment 29, wherein the key request comprises: a nonce; and
determining the discovery key corresponding to the LTK ID based on the key request comprises:
determining the discovery key based on the LTK corresponding to the LTK ID and the nonce in the key request.

Embodiment 32. The method according to embodiment 29, wherein the key request comprises: an identifier of the second UE; and
determining the discovery key corresponding to the LTK ID based on the key request comprises:
determining that the second UE has a right to monitoring based on the identifier of the second UE, and determining the discovery key corresponding to the LTK ID.

Embodiment 33. A UE discovery message protection apparatus, applied to first user equipment (UE), and comprising:
a first sending module, configured to send a first announcement message in response to determining that the first UE is located outside a network coverage range, wherein the first announcement message comprises: a discovery message encrypted based on a discovery key, and long-term key (LTK) identifier information (ID) indicating an LTK;
wherein the discovery key is determined based on the LTK received in response to determining that the first UE is located within the network coverage range; and the LTK ID is used for allowing second UE to determine a key request to request the discovery key or request to generate an intermediate key (KD) of the discovery key.

Embodiment 34. A UE discovery message protection apparatus, applied to second user equipment (UE), and comprising:
a second sending module, configured to send a key request to a ranging key management function (RKMF) based on monitoring a first announcement message, wherein the first announcement message is sent in response to determining that first UE is located outside a network coverage range and comprises: a discovery message encrypted based on a discovery key, and long-term key (LTK) identifier information (ID) indicating an LTK;
wherein the discovery key is determined by the first UE based on the LTK received in response to determining being within the network coverage range; wherein the key request comprises: the LTK ID; and the key request is used for requesting the discovery key or requesting to generate an intermediate key (KD) of the discovery key.

Embodiment 35. A UE discovery message protection apparatus, applied to a ranging key management function (RKMF), and comprising:
a third receiving module, configured to receive a key request sent by second UE, wherein the key request is sent after the second UE monitors a first announcement message; wherein the first announcement message is sent in response to determining that first UE is located outside a network coverage range and comprises: a discovery message encrypted based on a discovery key, and long-term key (LTK) identifier information (ID) indicating an LTK; wherein the discovery key is determined by the first UE based on the LTK received in response to determining being within the network coverage range; and the key request comprises: the LTK ID; and
a third processing module, configured to determine the discovery key corresponding to the LTK ID or generate an intermediate key (KD) of the discovery key based on the key request.

Embodiment 36. A communication device, comprising:
a processor; and
a memory configured to store executable instructions for the processor;
wherein the processor is configured to: implement the UE discovery message protection method according to any one of embodiments 1 to 11, or embodiments 12 to 23, or embodiments 24 to 32 when running the executable instructions.

Embodiment 37. A computer storage medium, storing a computer executable program, wherein the executable program implements the UE discovery message protection method according to any one of embodiments 1 to 11, or embodiments 12 to 23, or embodiments 24 to 32 in response to determining being executed by a processor.

1. A UE discovery message protection method, executed by a first user equipment (UE), and comprising:
sending a first announcement message in response to determining that the first UE is located outside a network coverage range, wherein the first announcement message comprises: a discovery message encrypted based on a discovery key, and long-term key (LTK) identifier information (ID) indicating an LTK;
wherein the discovery key is determined based on the LTK received in response to determining that the first UE is located within the network coverage range; and the LTK ID is used for allowing a second UE to determine a key request to request the discovery key or request to generate an intermediate key (KD) of the discovery key.

2. The UE discovery message protection method according to claim 1, before sending the first announcement message, comprising:
sending an LTK request carrying an identifier of the first UE to a ranging key management function (RKMF); and
receiving the LTK and the LTK ID returned by the RKMF based on the LTK request;
the method further comprising:
determining the discovery key based on the LTK; wherein the discovery key comprises at least one of the following:
a ranging encryption key (REK), used for encrypting the discovery message; or
a ranging integrity key (RIK), used for protecting integrity of the first announcement message.

3. (canceled)

4. The UE discovery message protection method according to claim 32, wherein determining the discovery key based on the LTK comprises:
determining the discovery key based on the LTK in response to determining that an available key sent by a network device is void;
wherein determining the discovery key based on the LTK comprises:
determining the KD based on the LTK;
determining a temporary key (KD-SESS) based on the KD; and
determining the REK and/or the RIK in the discovery key based on the KD-SESS;
wherein determining the KD based on the LTK comprises:
determining the KD based on the LTK and a nonce;
determining the temporary key (KD-SESS) based on the KD comprises:
determining the KD-SESS based on the KD and a nonce; and
determining the REK and/or the RIK in the discovery key based on the KD-SESS comprises:
determining the REK and/or the RIK in the discovery key based on the KD-SESS and a nonce.

5. (canceled)

6. (canceled)

7. (canceled)

8. The UE discovery message protection method according to claim 1, wherein the first announcement message further comprises at least one of the following:
a time stamp, used for indicating a validity duration of the discovery key;
a security algorithm identity, used for identifying a security algorithm used by the first announcement message;
a ranging query code used for identifying the first announcement message; and
a nonce, used for determining the discovery key together with the LTK.

9. The UE discovery message protection method according to claim 1, comprising:
receiving a second announcement message sent by the second UE, wherein the second announcement message carries a ranging response code corresponding to a ranging query code comprised in the first announcement message;
wherein the second announcement message is: the second announcement message protected based on the discovery key; and
the method further comprises: performing an integrity verification and/or decryption on the second announcement message based on the discovery key.

10. (canceled)

11. (canceled)

12. A UE discovery message protection method, executed by a second user equipment (UE), and comprising:
sending a key request to a ranging key management function (RKMF) based on monitoring a first announcement message, wherein the first announcement message is sent in response to determining that a first UE is located outside a network coverage range and comprises: a discovery message encrypted based on a discovery key, and long-term key (LTK) identifier information (ID) indicating an LTK;
wherein the discovery key is determined by the first UE based on the LTK received in response to determining being within the network coverage range; wherein the key request comprises: the LTK ID; and the key request is used for requesting the discovery key or requesting to generate an intermediate key (KD) of the discovery key.

13. The UE discovery message protection method according to claim 12, wherein monitoring the first announcement message comprises:
monitoring the first announcement message based on receiving a discovery response sent by the RKMF; wherein the discovery response is used for indicating that the second UE has a right to monitoring.

14. (canceled)

15. The UE discovery message protection method according to claim 13, comprising:
sending a discovery request carrying an identifier of the second UE to the RKMF, wherein the discovery request is used for requesting an authorization for the second UE to perform monitoring;
wherein the discovery response comprises at least one of the following:
a ranging query filter, used for matching a ranging query code;
a ranging response code corresponding to the ranging query code; or the LTK ID.

16. (canceled)

17. The UE discovery message protection method according to claim 12, comprising:
decrypting the discovery message based on the discovery key in response to determining that the discovery key sent by the RKMF is received; or,
determining the discovery key based on the KD in response to determining that the KD sent by the RKMF is received; and decrypting the discovery message based on the discovery key;
wherein the key request comprises: a nonce obtained from the first announcement message; and the nonce, together with the LTK ID, is used for allowing the RKMF to determine the discovery key or generate the KD of the discovery key.

18. The UE discovery message protection method according to claim 17, comprising:
determining whether the first announcement message is integral based on a ranging integrity key (RIK) in the discovery key; and
decrypting the discovery message based on the discovery key comprises:
decrypting the discovery message based on a ranging encryption key (REK) in the discovery key in response to determining that the first announcement message is integral.

19. (canceled)

20. The UE discovery message protection method according to claim 18, comprising:
determining whether the first announcement message is an announcement message that is subjected to a replay attack based on a time stamp and/or a nonce obtained from the first announcement message.

21. The UE discovery message protection method according to claim 17, comprising:
sending a second announcement message, wherein the second announcement message carries a ranging response code corresponding to the ranging query code included in the first announcement message;
wherein sending the second announcement message comprises:
sending the second announcement message based on the ranging query code in the first announcement message matching the ranging query filter.

22. (canceled)

23. (canceled)

24. A UE discovery message protection method, executed by a ranging key management function (RKMF), and comprising:
receiving a key request sent by a second UE, wherein the key request is sent after the second UE monitors a first announcement message; wherein the first announcement message is sent in response to determining that a first UE is located outside a network coverage range and comprises: a discovery message encrypted based on a discovery key, and long-term key (LTK) identifier information (ID) indicating an LTK; wherein the discovery key is determined by the first UE based on the LTK received in response to determining being within the network coverage range; and the key request comprises: the LTK ID; and
determining the discovery key corresponding to the LTK ID or generating an intermediate key (KD) of the discovery key based on the key request.

25. The UE discovery message protection method according to claim 24, comprising:
sending the discovery key or the KD to the second UE;
wherein determining the discovery key corresponding to the LTK ID based on the key request comprises:
determining the intermediate key (KD) based on the LTK corresponding to the LTK ID in the key request;
determining a temporary key (KD-SESS) based on the KD; and
determining the discovery key based on the KD-SESS.

26. The UE discovery message protection method according to claim 24, comprising:
receiving an LTK request sent by the first UE, wherein the LTK request comprises an identifier of the first UE; and
sending the LTK corresponding to the identifier of the first UE and the LTK ID to the first UE.

27. The UE discovery message protection method according to claim 24, comprising:
receiving a discovery request sent by the second UE, wherein the discovery request comprises: an identifier of the second UE;
determining whether the second UE has a right to monitoring based on the identifier of the second UE; and
sending a discovery response to the second UE in response to determining that the second UE has the right to monitoring; wherein the discovery response is used for indicating that the second UE has the right to monitoring;
wherein determining whether the second UE has the right to monitoring based on the identifier of the second UE comprises:
determining whether the second UE has the right to monitoring based on the identifier and configuration information of the second UE; wherein the configuration information comprises: a monitoring right corresponding to each piece of second UE.

28. (canceled)

29. (canceled)

30. (canceled)

31. The UE discovery message protection method according to claim 29, wherein the key request comprises: a nonce, and/or an identifier of the second UE;
determining the discovery key corresponding to the LTK ID based on the key request comprises:
determining the discovery key based on the LTK corresponding to the LTK ID and the nonce in the key request; and/or,
determining that the second UE has a right to monitoring based on the identifier of the second UE, and determining the discovery key corresponding to the LTK ID.

32-35. (canceled)

36. A communication device, comprising:
one or more processors; and
a memory configured to store executable instructions;
wherein the one or more processors are collectively configured to: execute the UE discovery message protection method according to claim 1 when running the executable instructions.

37. A communication device, comprising:
one or more processors; and
a memory configured to store executable instructions;
wherein the one or more processor are collectively configured to: implement the UE discovery message protection method according to claim 12 when running the executable instructions.

38. A communication device, comprising:
one or more processor; and
a memory configured to store executable instructions;
wherein the one or more processors are collectively configured to: implement the UE discovery message protection method according to claim 24 when running the executable instructions.
